(19) United States
(12) Patent Application Publication
(10) Pub. No.: US 2015/0098697 A1
(43) Pub. Date: Apr. 9, 2015

(54) SYSTEM AND METHOD FOR MODE DIVISION MULTIPLEXING

(71) Applicant: YISSUM RESEARCH DEVELOPMENT COMPANY OF THE HEBREW UNIVERSITY OF JERUSALEM LTD., Jerusalem (IL)

(72) Inventors: Dan Mark Marom, Mevaseret Zion (IL); Miri Blau, Efrat (IL)

(21) Appl. No.: 14/396,898

(22) PCT Filed: Apr. 25, 2013
(86) PCT No.: PCT/IL2013/050361

§ 371 Date: Oct. 24, 2014

Related U.S. Application Data
(60) Provisional application No. 61/638,125, filed on Apr. 25, 2012.

(51) Int. Cl. H04J 14/04

(52) U.S. Cl. CPC H04J 14/04
USPC 398/44

(57) ABSTRACT

A system and method are provided for coupling a plurality of optical signals, such as data signals, between a corresponding plurality of single mode optical fibers (SMFs) and a multi-mode optical fiber (MMF), by optically coupling the optical signals of the SMFs with respective spaced-apart regions at a facet of the MMF, such that at least some of the regions partially overlap with a plurality of different spatial modes supported by the MMF. The optical coupling is performed by utilizing imaging and beam shaping optics configured to couple each of the SMF optical signals and the respective region at the MMF's optical pupil by carrying out the following: (i) imaging the SMF optical signal propagating in between the associated SMF and the respective region of the MMF to focus the optical signal emanating from the SMF onto the respective region or vice versa; and (ii) shaping the optical signal being focused to convert a lateral field distribution thereof, between a first predetermined field distribution corresponding to the SMF's spatial mode and a second predetermined field distribution at the respective region.

### TECHNOLOGICAL FIELD

The invention is in the field of mode division multiplexing and relates to a system and method for coupling optical signals between multiple single-mode fibers and a multi-mode fiber.

### REFERENCES

References considered to be relevant as background to the presently disclosed subject matter are listed below:
1. Berdagué and P. Facq, “Mode division multiplexing in optical fibers,” Appl. Opt. 21, 1950-1955 (1982)
2. R. Ryf, S. Randel, A. H. Gnauck, C. Bolle, R. Essiambre, P. Winzer, D. W. Peckham, A. McCurdy, and R. Lingle, “Space-division multiplexing over 10 km of three-mode fiber using coherent 6×6 MIMO processing,” OFC 2011, paper PDPB10.
3. S. Randel, R. Ryf, A. Sierra, P. J. Winzer, A. H. Gnauck, C. A. Bolle, R.-J. Essiambre, D. W. Peckham, A. McCurdy, and R. Lingle, “6×56-Gb/s mode-division multiplexed transmission over 33-km few-mode fiber enabled by 6×6 MIMO equalization,” Opt. Express 19, 16697-16707 (2011)
4. M. Salsi, C. Koebele, D. Sperti, P. Tran, P. Brindel, H. Mardoyan, S. Bigo, A. Boutin, F. Verluise, P. Sillard, M. Bigot-Astruc, L. Provost, F. Cerou, and G. Charlet, “Transmission at 2×100 Gb/s, over Two Modes of 40 km-long Prototype Few-Mode Fiber, using LCOS based Mode Multiplexer and Demultiplexer,” OFC 2011, paper PDPB9.
5. E. Ip, N. Bai, Y. Huang, E. Mateo, F. Yaman, M. Li, S. Bickham, S. Ten, J. Liñiares, C. Montero, V. Moreno, X. Prieto, V. Tse, K. Chung, A. Lau, H. Tam, C. Lu, Y. Luo, G. Peng and G. Li, “88×3×112-Gb/s WDM Transmission over 50 km of Three-Mode Fiber with Inline Few-Mode Fiber Amplifier,” ECOC 2011, paper Th.13.C.2 (2011).
6. R. R. Thomson, T. A. Birks, S. G. Leon-Saval, A. K. Kar, and J. Bland-Hawthorn, “Ultrafast laser inscription of an integrated photonic lantern,” Opt. Express 19, 5698-5705 (2011)
7. D. Noordegraaf, P. M. Skovgaard, M. D. Nielsen, and J. Bland-Hawthorn, “Efficient multi-mode to single-mode coupling in a photonic lantern,” Opt. Express 17, 1988-1994 (2009)
8. D. Noordegraaf, P. M. W. Skovgaard, M. D. Maack, J. Bland-Hawthorn, R. Haynes, and J. Lægsgaard, “Multi-mode to single-mode conversion in a 61 port Photonic Lantern,” Opt. Express 18, 4673-4678 (2010)
9. H. Büllow, “optical mode demultiplexing by optical mimo filtering of spatial samples”, Photonics Technology Letters 24, pp. 1045-1047, No. 12, (2012)
10. R. Ryf, M. A. Mestre, A. Gnauck, S. Randel, C. Schmidt, R. Essiambre, P. Winzer, R. Delbue, P. Pupalaikis, A. Sureka, Y. Sun, X. Jiang, D. Peckham, A. H. McCurdy, and R. Lingle, “Low-Loss Mode Coupler for Mode-Multiplexed transmission in Few-Mode Fiber,” OFC 2012, paper PDP5B.5 (2012).
11. H. Büllow, “Optical mode demultiplexing by optical MIMO filtering of spatial samples,” IEEE Photon. Technol. Lett., vol. 24, no. 12, pp. 1045-1047, Jun. 15, 2012.
12. N. K. Fontaine, R. Ryf, J. Bland-Hawthorn, and S. G. Leon-Saval, “Geometric requirements for photonic lanterns in space division multiplexing,” Opt. Express 20, 27123-27132 (2012)

Acknowledgement of the above references herein is not to be inferred as meaning that these are in any way relevant to the patentability of the presently disclosed subject matter.

### BACKGROUND

The incessantly increasing data capacity that optical networks are transporting implies that within a few years we may reach the maximal attainable capacity over a single mode fiber (SMF). Space-division (i.e. space domain) multiplexing (SDM) has been attracting great attention recently, as a means to overcome the transmission capacity exhaust of SMF (see reference 1). The spatial degree of freedom can be exploited by introducing additional conduits of information (see references 2-6). By transmitting over a set of different fibers, over multi-core fiber, or over different modes of a multi-mode/few-mode fiber (MMF/FMF). The FMF approach advantageously provides a capacity boost without a fiber count increase and only one physical port has to be managed. One of the technical challenges associated with the SDM solution based on the FMF approach, is the efficient mode-division multiplexing (MDM), which is required for loading the information conduits (or modes of the FMF) with data signals.

The conventional technique for MDM, which has been exclusively used in the past, is based on mode conversion manipulations combined with passive combining and splitting. In the mode conversion multiplexing approach, phase masks (either static or dynamic masks, as indicated for example in references 2, 4, 6 and 7) are inserted in the beam paths in order to map each multiplexed mode to a separate de-multiplexed single mode fiber (and vice versa).

Had there been no mode mixing throughout transmission, the information channel, originating from a SMF, converted to a specific mode on a FMF with a mode conversion multiplexer, and reconverted back to an output SMF by a mode conversion de-multiplexer, would have remained pristine and amenable for detection. In practice, mode mixing throughout the transmission fiber due to inhomogeneities results in distributed information mixing among the propagating modes, and necessitates the use of a multiple input, multiple output (MIMO) receiver to unravel the original information channels.

Aperture-sampling mode multiplexing/de-multiplexing is an alternative MDM technique, which eliminates the need for the splitter/combiner and their associated losses. The basic operating principle of this technique is the multiple spatial sampling of the FMF/MMF output light radiation (collecting fractions of each propagating mode) instead of the conversion of each mode and its subsequent splitter loss. By sampling the FMF facet, all guided modes are coupled to an SMF array, each mode with finite efficiency.

One arrangement for implementing the aperture-sampling mode multiplexing technique, utilizes adiabatic tapering down of a SMF bundle to match the FMF aperture, often called ‘Photonic Lantern’ (see reference 6). Photonic lanterns were first introduced in the field of astrophysics, and were subsequently adopted for optical communication (see references 7, 8 and 11).

In an alternative method for implementing the aperture-sampling mode multiplexing technique, the individual apertures are abruptly coupled to the FMF by free-space imaging or by direct contact. An aperture sampling multiplexer has been demonstrated for the simplest case of direct imaging of the SMF end-faces onto the FMF supporting three modes, achieving an IL-4 dB (see for example reference 8). The free space imaging approach has been demonstrated for a three mode fiber (see reference 10), wherein the excitation of each fiber spatial mode is obtained from each input single mode fiber by forming, from the single mode fiber, a beam at correct position on the facet of the MMF.

In both the adiabatic and abrupt alternatives, the individual beams of the multiple input SMF sources are mapped onto distinct locations within the FMF core. Each SMF image serves as an independent source and illuminates a finite aperture of the fiber face, hence couples with fixed efficiency to each linearly polarized (LPₙₘ) mode of the FMF, where n and m are the azimuthal and radial orders, respectively.

### General Description

The known techniques for spatial domain multiplexing (SDM) are generally associated with deteriorated efficiency which results from relatively high losses such as insertion losses (IL), defined as the power coupling efficiency between any mode to the sum of all apertures, and mode-dependent losses (MDL), defined as the difference between the mode having the highest IL and the mode having the IL.

Specifically, conventional MDM mode conversion techniques (described for example in references 2-5), utilize spatial phase masks/manipulations to provide high efficiency in converting between higher-order modes (of the MMF) and the fundamental LP01 mode (of the SMF). However, the overall multiplexing efficiency of these techniques deteriorate due to the requisite splitting/combining process by which overall high insertion losses (IL) are obtained. Thus, the main advantage of the beam conversion multiplexer, which by design maps each spatial mode of the FMF to a separated mode of a SMF, is generally not used and the overhead of MIMO signal processing after coherent reception of all modes cannot be avoided. Moreover, the beam conversion multiplexers are associated with inherently high insertion loss (IL) metrics, due to the passive combining/splitting losses. For example, a three mode beam-conversion multiplexer has inherent IL of ⅓ (−4.8 dB). With added beam-conversion losses, realizations of these multiplexers achieve a −8 dB IL. The inherent inefficiency grows rapidly with mode count, which limits the scaling potential of the mode conversion solution. For example, implementing such technique for a six mode MMF yields an inherent IL of ⅙ (−7.8 dB).

The spatial aperture-sampling mode multiplexer/de-multiplexer technique (also referred to herein as aperture sampling multiplexing), eliminates the need for using splitters/combiners and their associated losses. The individual beams of the multiple input SMF sources are imaged onto distinct locations within the FMF core. Each SMF image serves as an independent source and illuminates a finite aperture of the fiber face, hence will couple with fixed efficiency to each mode of the FMF. As the excitation distribution of the modes at the aperture sampling multiplexer is fixed, the information can be recouped by the MIMO receiver. In other words, as a MIMO receiver is anyway required for handling the mode mixing in transmission, the multiplexer requirements may be relaxed, while exploiting the processing capabilities of the digital signal processor (DSP) of the MIMO receiver to also estimate or be provided a-priori, the coupling matrix elements associated with the mode mixing.

However, although the known aperture sampling multiplexer techniques obviate the use of splitters/combiners, some of these technique, e.g. those based one adiabatic SMF-MMF transition (adiabatic SMF tapering) suffer from the sensitivity disadvantages of the adiabatic process, requiring the waveguides to transition slowly and smoothly and be placed in accurate positions; deviations from said conditions give rise to losses in the form of IL and MDL. Also the conventional aperture sampling techniques which are based on abrupt SMF-MMF transition (e.g. SMF-MMF coupling by free-space imaging or direct contact), suffer from incomplete energy transfer resulting in IL and nonuniformities leading to MDL.

The present invention provides, a novel improvement to the mode division multiplexing technique for coupling light between multiple single-mode fibers (SMF) and a multi-mode fiber, which is practically a few-mode fiber (FMF). The terms/abbreviations MMF and FMF are used herein interchangeably, and should be thus properly interpreted. The invention utilizes the principles of the aperture sampling multiplexing described above, while providing an optimized aperture sampling with an optimized abrupt SMFs-MMF transition/coupling resulting with reduced losses (insertion losses and mode dependent losses). In particular, some embodiments of the invention utilize abrupt coupling of plurality of SMFs to an MMF (e.g. via imaging optics) while beam shaping the coupled optical signals/beams such as to reduce the insertion losses and/or the mode dependent losses.

It should be understood that the terms few- and multi-mode fiber (FMF & MMF) are used in the following description interchangeably to indicate optical fibers supporting optical signal transmission in more than one spatial/lateral modes). On the contrary, the term single-mode fiber (SMF) is used herein to indicate optical fiber supporting optical signal transmission in a single spatial/lateral mode.

According to the invention, light/optical signals are coupled between N (N>1) single-mode fibers and an N-mode fiber (MMF of N spatial modes), wherein N spatially separated light components from N single-mode fibers are imaged onto N spaced-apart regions (apertures) of predetermined geometries and intensity distributions, on an optical pupil (e.g. a facet of the fiber's core) of the N-mode fiber. Each region/aperture corresponds to plurality of spatial modes of the N-mode fiber. Generally, according to the present invention, the projection of each light component/optical signal of a respective SMF is with substantially not-Gaussian lateral intensity profile/distribution ant a respective region of the MMF's pupil.

This is achieved by coupling N light components from the N single-mode fibers to N respective regions (apertures) on the N-mode fiber, while applying beam shaping to map/convert the shape in between substantially circular Gaussian light component (spatial mode) of each single-mode fiber and a predetermined lateral intensity profile of the light spot at the respective region/aperture in the multi-mode fiber, and imaging each of the light components, being shaped, onto a the respective region/aperture of the MMF fiber. According to the invention, the predetermined lateral intensity profile of the apertures/spots and arrangement and geometry of the apertures' regions, on to at the MMF's pupil, are selected to maintain the substantially orthogonal mapping vectors requirement and to thereby reduce/optimize coupling and mode dependent losses (MDLs).

It should be noted here that the term aperture is used herein to indicate a region of illumination of the MMF's facet/pupil having certain geometry and a certain predetermined intensity distribution of the illumination. Each of the aperture are associated/coupled to a certain SMF. When multiplexing optical signals of plurality of SMFs, the optical signal of each SMF is projected (imaged and beam-shaped) on a respective aperture region with a predetermined intensity distribution (vice versa in de-multiplexing). Thus, in de-multiplexing, the intensity distribution of light/optical signal at each aperture region, is projected (imaged and beam shaped) on to the pupil/core of the respective SMF, while being beam shaped to an appropriate intensity distribution on the SMF's pupil (typically beam shaped to a circular Gaussian intensity distribution that matches the single spatial mode supported by the SMF). In this connection, it should be understood that according to the spatial aperture-sampling mode multiplexing technique, the apertures are respectively associated with excitations of multiple spatial modes in the MMF. Namely, there is no one to one correspondence between apertures and spatial modes, and one or more apertures (typically some or all of the apertures) are each associated with excitation of plurality of spatial modes of the MMF.

As the excitation distribution of the modes at the spatial aperture-sampling mode multiplexer is fixed, the information that is scrambled in multiplexing and demultiplexing, may be recovered by multiple input multiple output (MIMO) processing at the receiver. To this end, in order to enable full detection and recovery of the original data with no information loss, the mapping matrixξ, which maps the apertures at which light spots/optical signals of respective SMFs is projected/imaged, should be ideally a unitary transformation from the spatial-mode domain of the FMF and aperture domain, and vice versa. The mapping matrix ξ can generally be represented as:

$${LP}_{j =} {ξ}_{ij} {ϕ}_{i} \to ( \begin{matrix}{LP}_{01} \\ {LP}_{11 v} \\ {LP}_{11 h} \\ …\end{matrix} ) = ( \begin{matrix}{ξ}_{11} & {ξ}_{12} & {ξ}_{13} & … \\ {ξ}_{21} & {ξ}_{22} & {ξ}_{23} & … \\ {ξ}_{31} & {ξ}_{32} & {ξ}_{33} & … \\ … & … & … & …\end{matrix} ) ( \begin{matrix}{ϕ}_{1} \\ {ϕ}_{2} \\ {ϕ}_{3} \\ …\end{matrix} ) \qquad Eq . ( 1 )$$

where φᵢ represent the apertures to at the entry pupil of the MMF (wherein each aperture is associated with a respective SMF, LPⱼ represents the spatial modes supported by the MMF (for example linearly polarized modes of step-index dielectric fiber may be considered or orbital angular momentum modes of a ring fiber), and ξᵢⱼ presenting the coupling values between the apertures and the spatial modes (e.g. ξᵢⱼ is the complex amplitude mapping from the j^{th} mode to the i^{th} aperture). The coupling value ξᵢⱼ indicate the i^{th} aperture contribution to the excitation of the j^{th} spatial mode of the MMF. The coupling value ξᵢⱼ can be evaluated as the overlap integral between the optical-field (intensity distribution) of the optical signal originating from the i^{th} SMF (i.e. as projected on the i^{th} aperture) and the optical field distribution of the j^{th} spatial mode of the MMF. The overlap integral is evaluated by integrating over the entire cross-section of the two field distributions.

To this end, the light coupling system of the present invention includes a beam shaping and an imaging assembly configured to provide optimized coupling between the SMF light/optical signals and the MMF modes. The beam shaping and imaging assembly typically include imaging optics (e.g. lenses) and beam shaper(s) (typically phase manipulations) which may be formed for example as active spatial light modulator (e.g. liquid crystal panel) or preferably passive spatial phase distributions (in the form of diffractive or refractive elements). It should be understood that optical elements of the beam shaping and imaging assembly, may in some cases be formed as separate elements and/or in some cases, some of the functional elements may be integrated together to a single optical element performing optical functions relating to both beam shaping (e.g. phase shift) and imaging (beam collimation and/or focusing).

To this end, the technique of the present invention allows for utilizing standard MIMO processing. This is because the excitation distribution of the MMF's spatial modes obtained by the optimized aperture-sampling mode multiplexing technique of the invention is fixed. Accordingly the standard MIMO processing requirement that the transformation from mode domain to aperture domain be substantially unitary may be satisfied. Unitary transformation can be achieved if the mapping vectors are orthogonal to each other and of unit magnitude (i.e. orthonormal), so as long as the orthogonality between the distributions is maintained, and the coupling efficiencies are uniform for all modes, the mixing of data channels in the FMF is reversible, relying on the fixed mapping from apertures to modes (see for example reference 11 and the publication “Optimization of Spatial Aperture-Sampled Mode Multiplexer for a Three-Mode Fiber” by M. Blau and Dan M. Marom, Photonics Technology Letters, Volume: 24, Issue: 23. P. 2101-2104 (2012).

The mapping matrix from apertures to modes, ξ, describing the multiplexing operation can be transposed, ξ^{T}, thereby describing the de-multiplexing mapping operation from modes to apertures. The cumulative effect of multiplexing and de-multiplexing (neglecting fiber mode mixing which is handled by MIMO) can therefore be described by the matrix operation ξ^{T}ξ. If the mapping operation ξ is orthonromal (i.e. the vectors ξᵢ are orthogonal and of unit magnitude), then the matrix product ξ^{T}ξ is the identity matrix and all information is preserved, and readily available for detection. If the magnitude is not unity but orthogonal, then the matrix product ξ^{T}ξ is a diagonal matrix and its trace element measure the IL of the modes.

In practice, modes mix throughout transmission in a FMF, hence the recovered signal is ξ^{T}Aξ, where A describes the modal mixing operation in transmission which ideally is a unitary transformation. The recovered signal at each de-multiplexer SMF output contains a superimposed signal of all modes with different, time-varying, amplitudes, phases and differential time delays, as a result of the mixing matrix A. Since all involved matrices may be considered unitary or nearly unitary, the information can be recovered from the received de-multiplexed channels after coherent detection, with the aid of MIMO processing which attempts to invert the modal mixing matrix A.

Thus, a prominent requirement for the mapping between the MMF modes and individual apertures (which are associated/coupled to the respective SMFs) is that the mapping vectors ξᵢ be orthogonal and their magnitudes be large and equal. Choosing the number of apertures (i.e. SMF spots) to be identical to the propagating mode count in the MMF results in a square transformation matrix ξ, thereby matching the ranks of the two spaces of apertures and MMF modes.

Conventional techniques for coupling several SMFs to an MMF using the abrupt transition (e.g. based on free-space imaging or direct contact), yield an incomplete energy transfer which results in losses and in particular, in addition to insertion losses, also exist are mode dependent losses MDL which impair the uniformity of the trace elements of the diagonal matrix ξ^{T}ξ. This impairs the ability to recover information from the signal(s) transferred in the MMF.

In order to maximize information capacity, the mapping vectors of the coupling matrix ξ should give insertion losses that are substantially uniform for all the modes of the MMF (i.e. providing negligible/zero MDL). In other words the mapping vectors should be substantially orthogonal, even if their magnitude is less than unity (i.e. even if they are not orthonormal). However, currently, non-uniform efficiency for mode mapping vectors is obtained by conventional MDM techniques utilizing the special aperture sampling based on abrupt transition between SMFs and MMF. These conventional techniques result in different trace elements ξ^{T}ξ, which is translated to MDL and mode-dependent performance degradation.

Therefore, the object of the present invention can be listed as ensuring that the mapping vectors are orthogonal, and optimizing the apertures to a criterion such as: equaling the magnitudes of the mapping vectors which leads to a minimal MDL criterion, or maximizing the average magnitude of all mapping vectors which leads to minimal IL criterion, or a combination thereof. The invention provides for defining apertures (i.e. geometries/shapes, locations and optical field/intensity distributions) of the SMFs spots on the entry pupil of the FMF such that the mapping vectors ξᵢ are orthogonal, with minimal losses and high uniformity.

According to one broad aspect of the invention, there is provided a method for coupling a plurality of optical signals between a corresponding plurality of single mode optical fibers (SMFs) and a multi-mode optical fiber (MMF). The method comprises optically coupling the optical signals of the SMFs with respective spaced-apart regions at an optical pupil of an MMF, such that at least some of said regions partially overlap with a plurality of different spatial modes supported by the MMF. Such optical coupling for each of the SMF optical signals and the respective region at the MMF's optical pupil comprises:

i. Imaging the SMF optical signal propagating in between the associated SMF and said respective region of the MMF to focus the optical signal emanating from the SMF onto the respective region or vice versa; and

ii. shaping said optical signal being focused to convert a lateral field distribution thereof between a first predetermined field distribution corresponding to the SMF's spatial mode and a second predetermined field distribution of said respective region.

The second predetermined field distribution of the region at the optical pupil of the MMF may be associated with the excitation of a plurality of spatial modes in said MMF. Also, a number of the spatial modes supported by said MMF may equal the number of said SMFs.

The spaced-apart regions may be distinct, non-overlapping regions on the MMF's pupil. The second predetermined field distribution may be selected to provided spatial domain multiplexing of the SMFs optical signals in the MMF while optimizing at least one of an insertion loss (IL) and mode-dependent losses (MDL). The second predetermined field distribution may correspond to at least one of the following field distribution functions: two dimensional Gaussian field distribution with certain eccentricity; and/or two dimensional field distribution functions defined by separable radial and azimuthal functional components. For example, the radial functional components may be selected from at least one of the following: a Bessel function, and a function corresponding to a radial field distribution of a fundamental mode of the MMF. As for azimuthal functional components, they may be selected from at least one of the following: a raised cosine function, and a cosine raised to power x function.

The first predetermined field distribution may correspond to at least one of the following: Gaussian field distribution, a circular Gaussian field distribution, and a function corresponding to the field distribution of a fundamental mode of the SMF. The MMF may be a step-index fiber, and the spatial modes of the MMF may be linearly polarized modes. Also, the MMF may comprise a fiber having annular refractive index profile (at time referred to as a ring fiber), and the spatial modes of the MMF are orbital angular momentum (OAM) modes.

The beam shaping may utilize at least one of the following: intensity re-distribution and wavefront correction optical elements, whether refractive or diffractive in nature; anamorphic optical elements; and attenuating optical elements. For example, when utilizing intensity re-distribution and wavefront correction optical elements, the beam shaping may comprise modifying the intensity profile of the optical signal propagating in between the associated SMF and said MMF such as to obtain a certain predetermined intensity profile at a certain optical plane intersecting a propagation path of the optical signal, and applying phase correction to the optical signal at said optical plane to obtain a certain predetermined wavefront of the optical signal at said plane. The predetermined intensity profile may correspond to at least one of said first and second predetermined field distributions and said certain predetermined wavefront corresponds to a plane wave wavefront.

In some embodiments, the imaging comprises coupling between the SMF and the respective region of said MMF by collimating the optical signal associated with said SMF.

In some embodiments, the spaced-apart regions are arranged with asymmetric arrangement at said optical pupil of the MMF. For example, such asymmetric arrangement may comprise an arrangement of the regions in m concentric circles with 2n+1 regions equally spaced along an outer circle of said concentric circles, where m is the highest radial mode order, and n is the highest azimuthal mode order supported by the MMF.

In some embodiments, an arrangement of the plurality of regions and said second predetermined field distribution at each of the respective regions are selected such that a coupling matrix relating to projection of the optical signals between the associated SMFs and said regions and to the multiple spatial modes of said MMF is a substantially orthogonal matrix.

According to another broad aspect of the invention, there is provided an optical signal coupling system for coupling optical signals between a plurality of single mode optical fibers (SMFs) and a multi-mode optical fiber (MMF), the system comprises: beam shaping and imaging optics configured and operable together for optically coupling the optical signals of the SMFs with respective spaced-apart regions at an optical pupil of the MMF, wherein said imaging optics comprises focusing optics for focusing the optical signals associated with the SMFs onto the respective region at the MMF's pupil or vice versa; and said beam shaping optics is configured to convert lateral field distribution of each of the optical signals in between a first predetermined field distribution corresponding to a spatial mode of the associated SMF and a second predetermined field distribution at said respective region.

According to yet another broad aspect of the invention, there is provided a method for optimizing spatial mode multiplexing/de-multiplexing of signal between a plurality of N single mode fibers and a common multimode fiber, the method comprising:

providing at least one field distribution function which can be synthesized by spatial beam shaping;

selecting an arrangement of N regions in an optical pupil of said MMF and optimizing scaling of said field distribution functions in each of said regions in accordance with said arrangement;

varying one or more degrees of freedom, being optimization parameters, of said field distribution function, while estimating at least one of an insertion loss (IL) and mode-dependent loss (MDL) associated one or more variations of said degrees of freedom and comparing said variations with respective thresholds of at least one of said IL and MDL to screen out variations exceeding said thresholds,

thereby providing one or more variations, each corresponding to a specific arrangement of said regions, and to optimized parameters of specific field distribution functions, for which said IL and MDL losses are optimized.

In some embodiments, tolerance thresholds are provided being associated with at least one of production tolerances and fiber alignment tolerances related to said spatial mode multiplexing, and screening out variations which require accuracy higher than said tolerances.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a block diagram of spatial aperture sampling mode multiplexer/de-multiplexer system 100 according to an embodiment of the present invention;

FIG. 1B is a flow chart of a method for mode division multiplexing according to an embodiment of the optimized spatial aperture sampling mode multiplexing technique of the present invention;

FIG. 1C is a flow chart of a method according to an embodiment of the present invention for determining optimized apertures/intensity-distributions for use with the optimized spatial aperture sampling mode SDM multiplexing technique of the invention;

FIG. 1D is a graphical illustration showing profiles of several functional forms of exemplifying intensity/field distributions of different aperture types;

FIG. 2A shows an example of a spatial aperture sampling mode multiplexer system 100 according to an embodiment of the present invention;

FIG. 2B depicts three field distributions ψ₁-ψ₃ of respectively three linearly polarized spatial modes LP01, LP11v and LP11h of a three mode fiber;

FIGS. 3A to 3D respectively depict simulations of four intensity/field distributions (apertures types) subtending the three modes of the three-mode fiber core/pupil;

FIG. 4 shows graphs of the insertion losses and the mode dependent losses obtained by utilizing apertures type configuration similar to that of FIG. 3D, with the aperture intensity/field distributions composed of the Bessel function in the radial direction and the raised cosine function in the azimuthal direction;

FIGS. 5A and 5B depict the field distributions of modes in the multi-mode fibers supporting six and ten spatial modes respectively;

FIG. 5C is a graphical representation of the dispersion curve of LP modes in step index fibers;

FIG. 6A is a graph illustrating a refractive index profile of the ring fiber;

FIG. 6B is an illustration depicting of the intensity and phase patterns of the propagating orbital angular momentum (OAM) modes in the nine mode ring fiber of FIG. 6A;

FIGS. 7A-7D are MDL vs. IL scatter plots illustrating the results of aperture optimization performed for a six mode step index fiber;

FIG. 7E graphically presents the leading performance edges of the accessible optimization spaces of the various apertures distribution function simulated in FIGS. 7A-7D;

FIG. 7F, shows a Monte Carlo simulation of the effect of fiber placement error;

FIGS. 8A-8D are MDL vs. IL scatter plots illustrating the results of aperture optimization performed for a ten mode step index fiber, and FIG. 8E shows the leading performance edges of the various apertures simulated in FIGS. 8A-8D;

FIGS. 9A-9D are MDL vs. IL scatter plots illustrating the results of aperture optimization performed for a nine mode ring fiber; and FIG. 9E shows the leading performance edges of the various apertures simulated in FIGS. 9A-9D;

### DETAILED DESCRIPTION OF EMBODIMENTS

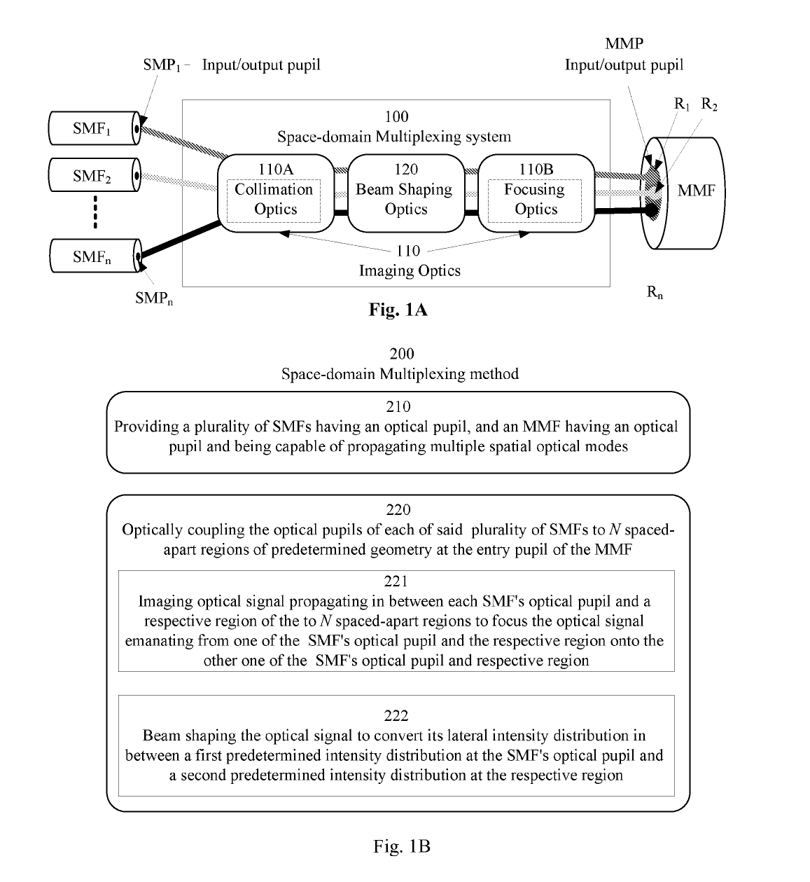

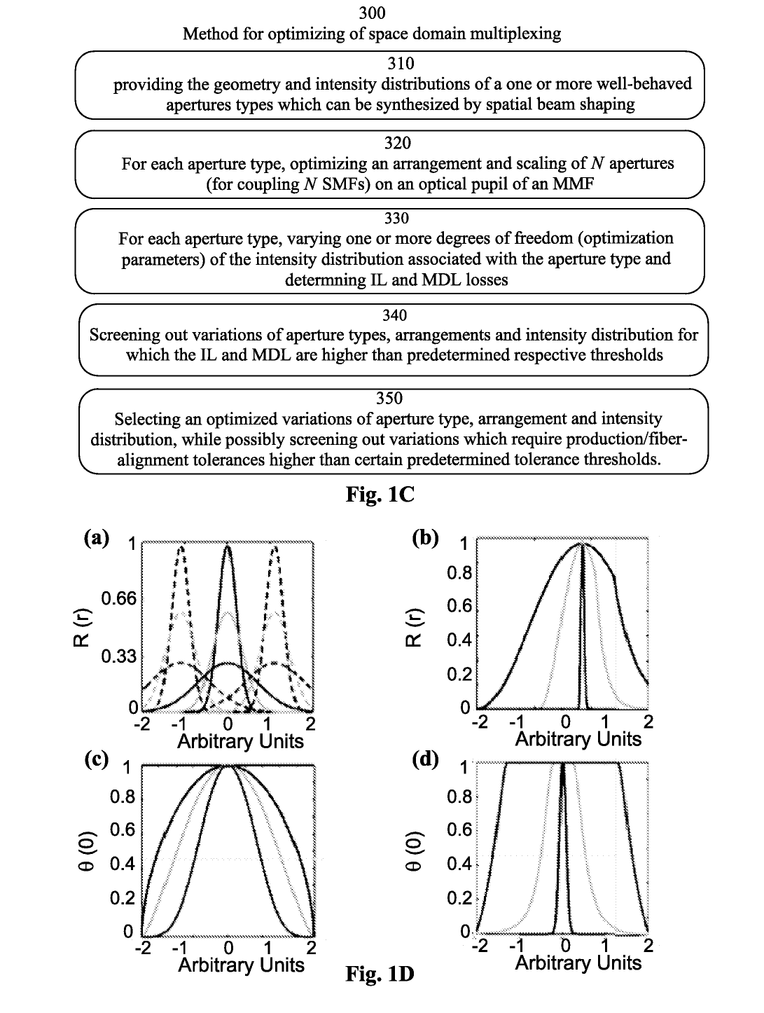

Reference is made together to FIGS. 1A and 1B respectively illustrating a block diagram of spatial aperture sampling mode multiplexer system 100 and a flow chart of method 200 configured according to an embodiment of the present invention for implementing space domain multiplexing/demultiplexing by coupling multiple SMFs with an MMF in accordance with the optimized spatial aperture sampling mode multiplexing technique of the invention.

In this connection, it should be understood that the system and method, 100 and 200, may be operated symmetrically for spatial mode multiplexing of optical signals emanating from the pupils of the plurality of SMFs, SMF₁-SFMₙ, and coupling them to the pupil of the MMF MMF. Alternatively or additionally, by operating in the reverse order (e.g. where the order of the operations of method 200 is reversed, namely the propagation direction of the optical signals through system 100 are inversed) the system and method, 100 and 200, may operated for de-multiplexing spatial mode multiplexed optical signal/beam emanating from the MMF MMF and coupling the de-multiplexed signal respectively in to the plurality of SMFs SMF₁-SMFₙ.

System 100 is configured for performing spatial mode multiplexing/de-multiplexing by utilizing both imaging optics/modules 110 and beam shaping optics/modules 120. Modules 110 and 120 are configured together for coupling light between the SMFs and the MMF while providing efficient conversion between the plurality of SMFs optical signals (projected on respective apertures on the MMF's pupil) and the field distribution of the spatial modes propagating in the MMF. As will be further described below the use of specifically configured beam shaping and imaging optics, 110 and 120, allows for reducing the losses conventionally associated with such SMFs to MMF couplings.

The beam shaping optics 120 provides for converting between the field/intensity distribution of the propagating (fundamental modes) of the SMFs and predetermined intensity distribution(s) on the MMF's pupil, such that the predetermined intensity distribution is obtained providing improved coupling to between the SMF's fundamental mode and the plurality of the MMF modes. The imaging optics provides for projecting the optical signals of the SMFs onto spaced apart locations on the MMF's pupil/facet (e.g. the optics is configured for collimating the outputted signals and focusing them onto desired locations). Specifically, the imaging optics allows to respectively coupling the SMFs' light/optical-signals with distinct, non-overlapping regions on the MMF's pupil. The operation of the system 100 will be further clarified with the description of method 200.

The method 200 is adapted to provide optimized coupling of optical signals (e.g. optical data channels/signals) between a plurality single mode optical fibers SMF₁-SFMₙ (e.g. N fibers) and a multi-mode optical fiber MMF (e.g. a single MMF) by spatial domain mode multiplexing/de-multiplexing the optical signals during the transition between the plurality of SMFs and the MMF. The spatial aperture sampling mode multiplexing efficiency strongly depends on the shape and arrangement of the apertures/intensity distributions of the SMF's beams on the MMF's pupil. Accordingly, method 200, of optimizing the size and/or locations and/or shape/geometry of the apertures/intensity distributions has a significant influence on the average coupling IL and MDL.

In operation 210 provided are plurality of SMFs each having an optical pupil/facet being input/output facets SMP₁-SMPₙ of the single mode fibers SMF₁-SFMₙ respectively. Also provided is an MMF MMF having an optical pupil/facet MMP configured for receiving/outputting optical signals propagating in multiple transversal spatial modes in the multi mode fiber MMF. The optical pupils SMP₁-SMPₙ and MMP are configured for receiving and/or emanating optical signals propagating in the respective fibers. The MMF being capable of propagating multiple spatial optical modes. The number N′ of the multiple spatial optical modes is less than or equal to, the number N of the SMFs.

In operation 220, the plurality of SMFs, SMF₁-SFMₙ, are optically coupled to the multi-mode fiber MMF. The technique of the present invention for optical coupling SMFs to MMF is based on the aperture sampling technique and accordingly the optical pupils SMP₁-SMPₙ of each of plurality of SMFs are coupled to N spaced-apart regions/apertures (namely to different/distinct regions) at the optical pupil MMP of the MMF, such that each aperture corresponds to plurality of spatial modes of the MMF. To this end, in multiplexing operation the SMF's light components (e.g. optical signals/spots) are respectively shaped, (e.g. utilizing beam shaping optics 120) and imaged (e.g. utilizing imaging optics 110) on to the respective regions/apertures at the MMF's optical pupil MMP and vice-versa in de-multiplexing operation. The SMF light beams are imaged onto respective predetermined regions/apertures on the MMF's optical pupil and are beam-shaped to form predetermined intensity distribution on those predetermined regions such that the mapping between the intensity distributions of the SMF light beams imaged on the MMF's pupil and the lateral intensity distribution of the multiple spatial modes of the MMF can be represented by a substantially orthogonal matrix ξ. As will be further described and illustrated below, the geometry and lateral intensity distribution of the imaged SMFs' spots on the MMF's entry pupil MMP are specifically designed to improve the optical coupling between the SMFs and the MMF (reduce losses) and also to improve data recovery (i.e. preserve substantial orthogonality of the matrix ξ) by reducing the mode dependent losses. To this end, the intensity distributions and geometries of the SMFs' spots on the MMF's pupil is selected to optimize the coupling matrix ξ towards a substantially unitary form, such that ξ^{T}ξ is close to unity with low and/or relatively uniform insertion losses and/or reduced mode dependent losses.

To this end, the modal insertion losses (IL) may be defined for example by the trace elements of the diagonal matrix, formed from the coupling matrix multiplied by its transpose ξ^{T}, namely: IL=Trace(ξ^{T}ξ). The average IL is defined by the average of said trace elements and mode dependent losses MDL may be defined by the difference between the largest and smallest of the trace elements of the IL matrix.

More specifically, considering the case where the MMF MMF supports N propagating spatial orthogonal modes, where the i'th mode has a transverse normalized field/intensity distribution of ψᵢ(x,y). The coupling of the SMF's light components to lateral modes is realized/presented by a projection of the SMF's light components/beams (e.g. by beam shaping and imaging) on to specific regions at the MMF's pupil MMP. The coupling coefficients ξᵢₖ between the spatial orthogonal modes of the MMF and the light component of each SMF, SMFₖ may be defined as a coupling integral between each mode and a finite normalized intensity distribution φₖ(x,y) of the SMF's beam as projected on a region/aperture of the MMF's pupil. Namely:

∫ψᵢ·φₖ*dA=ξᵢₖ, Eq. (2)

wherein the integration is carried out over the lateral coordinates x and y and covers the lateral cross-section of the MMF's pupil (e.g. the cross-section of the MMF's core), φₖ(x,y) is the normalized beam field distribution, defined over a finite, non-overlapping region of the MMF's pupil.

It is important to note that aperture sampling multiplexer technique of the present invention is different from some of the known multiplexing technique which utilize free space imaging, at least by that according to the technique of the present invention, each aperture serves as an independent source which couples to multiple/all propagating fiber modes (namely coupling information from one N dimensional space (of the N apertures) to another N dimensional space (of the MMF's spatial modes) via the coupling matrix ξ which describes the projection/coupling operation. On the contrary, in the conventional multiplexing techniques utilizing the mode conversion technique the single mode excitation of each fiber mode is obtained by forming from each input single mode fiber a field distribution that exactly matches a corresponding fiber spatial mode. Namely, in such conventional techniques, MMF mode to SMF correspondence is used.

The calculation of the mode coupling coefficients ξᵢₖ shown in Eq. (2) as well as the IL and MDL calculations described herein are made without consideration of the polarization degree of freedom. However, since the two polarization states are orthogonal in fiber modes and in the projection operation (which operates in the scalar regime), the technique extends independently over both polarization states. To this end, the space domain multiplexing technique of the present invention, which is based on the free space aperture sampling multiplexing, may be implements also with three-dimensional guided waveguides, such as those being developed for chip to chip interconnect by photonic wire-bonds (e.g. see for example reference 12) as well as three dimensional sculpted waveguides in bulk material by laser inscription.

To obtain optimized coupling between the SMF's and the MMF, the choice of intensity distribution φₖ(x,y) of the projection k^{th} SMF's beams on the MMF's pupil has to satisfy a few requirements for multiplexing and demultiplexing:

a) The number of apertures (e.g. the number of coupled SMFs) should match the number of modes, to match basis set size or in some cases the number of apertures can be greater than number of modes.
b) the total power transfer efficiency from mode ψᵢ onto the SMF's beams (demux) should be high, Σ|ξᵢₖ|².
c) the differences between total power transfer efficiencies per mode should be minimized, for low mode dependent loss (MDL); and
d) the projection operation should preferably maintain mode orthogonality,

[symbol]

ξᵢ₁,ξᵢ₂,ξᵢ₃ [symbol] · [symbol] ξⱼ₁,ξⱼ₂,ξⱼ₃ [symbol] *=0 for i≠j. Eq. (3)

This is achieved through judicious choice of aperture positions. However under realistic tolerances, the orthogonality is not strictly achieved, but MIMO processing can still operate faithfully if vector dot product is much smaller than the vector magnitudes (e.g., one tenth).

Thus, the optical system 100 is configured for coupling between the plurality of SMFs and the MMF and with the coupling matrix ξ, whose elements ξᵢₖ are the coupling coefficients from the i'th mode into the k'th aperture/SMF. The matrix transforms an N-dimensional vector of the modal content ψ to an N-dimensional vector of the finite aperture beam φ (demultiplexer). Its Hermitian conjugate, ξ^{†}, transforms back from the vector φ to fiber modes ψ (multiplexer). In cases the matrix ξ satisfies the orthogonality condition (Eq. (3)), than ξξ^{†} is a diagonal matrix with its trace elements are smaller than one due to losses (i.e. the transformation is not unitary), and the trace element differences contribute to MDL, which lead to capacity loss. In order to optimize the coupling between the plurality of SMFs to the MMF, optimized intensity distributions φₖ(x,y) of the SMFs beam on the pupil of the MMF fiber are provided. In the following, these intensity distributions φₖ(x,y) are referred to for clarity as apertures (e.g. or SMFs' apertures).

Reference is made to FIG. 1C which is a flow chart of a method 300 for optimization of space domain multiplexing by optimized apertures/intensity-distributions. Method 300 may be used for determining the desired properties of the imaging and beam shaping optics of system 100. Method 300 may be implemented by suitably configured computerized processing system configured and operable for carrying out optical simulation to determine properties of the optical coupling between the SMFs and the MMF in various variations/selections (hereinafter aperture variations) of properties of parameters relating the: (a) apertures types (i.e. being the functional forms of their intensity distributions), (b) the arrangement of the aperture on the facet pupil of the MMF, and (c) various optimization properties/parameters relating to the aperture scaling and to degrees of freedom of the apertures types/functions and arrangements.

The method includes operation 310 providing a one or more well-behaved aperture types (intensity distribution types) which can be practically synthesized by spatial beam shaping techniques. Each of the intensity distributions φₖ(x,y) having one or more parameters (optimization parameters) defining their shape and serving as degrees of freedom for optimization. In this regards the optimization utilizes the selection of a suitable aperture shape and intensity distribution. In the following several aperture shapes/intensity-distributions were considered for optimization including for example: circular Gaussian, elliptical Gaussian, azimuthal raised cosine, and azimuthal cosine raised to power x. It should be understood that the circular Gaussian case is provided as a benchmark for comparing against a conventional SMF imaging technique (i.e. which not utilize the beam shaping).

It should be noted that the aperture's shape and intensity distributions generally depend on the configuration/operational parameters of the beam shaping module 120. Accordingly after an optimized apertures are selected (e.g. after completion of method 300), the beam shaping module may be configured in accordance with these parameters.

In 320, for each aperture type, an arrangement and scaling/size of N apertures (for coupling N SMFs) on an optical pupil of an MMF selected/optimized. Specifically the sizes of the N SMFs' apertures and their arrangement on the optical pupil of the MMF (i.e. over the MMF facet) may generally be selected at this stage. It s noted that these parameters typically mainly relate to the configuration of the imaging optics 110 of system 100 and accordingly after the final optimized apertures (variation) is selected (e.g. in operation 350 below) the imaging optics 110 may be configured in accordance with these optimized parameters.

Typically the SMFs to MMF coupling is optimized/improved by selecting the size and arrangement of the apertures which best match the modal spatial structure of the propagating modes in the MMF fiber. Specifically, according to some embodiments of the present invention, a prominent requirement is an asymmetric arrangement of the apertures that the apertures are arranged arrangement is a asymmetric arrangement of the apertures enabling to distinguish between azimuthally degenerated spatial modes of the MMF (e.g. LP₁₁^{a}, LP₁₁^{b}). This is because a symmetric arrangement of apertures cannot distinguish between such azimuthally degenerate modes.

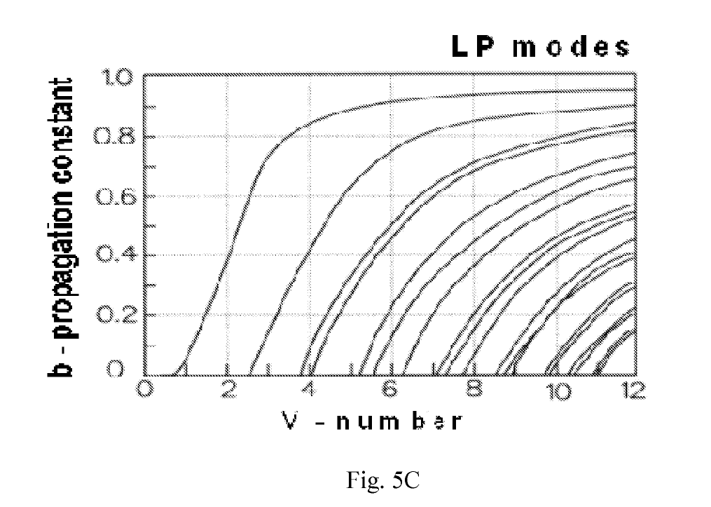

For example, considering the n and m azimuthal and radial mode orders, such an asymmetric arrangement may be realized by arranging the SMF's apertures on the MMF's pupil in m concentric circles (the smallest radius may be zero, as in the case of 6 fiber modes where there are 5 apertures on the outer ring and a single aperture at the center) where m is the highest radial mode count, with 2n+1 apertures equally spaced along the outer circle of these concentric circles, where n is the highest azimuthal mode order. Specifically, such an asymmetric arrangement may be suitably configured for a certain multi-mode fiber by selecting the n,m values to be of the highest supported mode. For example, for a six mode fiber (MMF), supporting the linearly polarized modes LP₀₁, LP₁₁, LP₀₂, and LP₂₁ such as those shown in FIG. 5A, the highest supported mode being n=2 and m=2. Accordingly, this corresponds to a configuration of five apertures (2n+1) on the outer circle and a single additional aperture in the inner circle (which has zero radius). In a ten-mode fiber, such as that exemplified with reference to FIG. 5B below, the additional modes supported are modes LP₁₂ and LP₃₁, in addition to the above listed modes of the six mode fiber. Thus, as now the highest supported azimuthal mode is n=3, seven apertures are located on the outer circle (2n+1) and the remaining three apertures (to match the dimensions of the aperture′ and mode′ spaces) are located on the inner circle. The number of concentric circles with non-zero radius remains 2 (being equal to radial mode count, 2). Considering the three-mode fiber with the three spatial modes LP₀₁ and LP₁₁ (namely LP₁₁^{v} and LP₁₁^{h}), the highest supported azimuthal mode in this case is n=1, thus three apertures (2n+1) should be located on the concentric circle. Thus, the number of apertures equals the number of supported modes (to match mode and aperture spaces), and orthogonality between the apertures is maintained through judicious arrangement and geometry (sizing) of the apertures (e.g. with no overlap between the apertures), in order to best preserve the information for subsequent electronic MIMO processing in cases where such processing is needed.

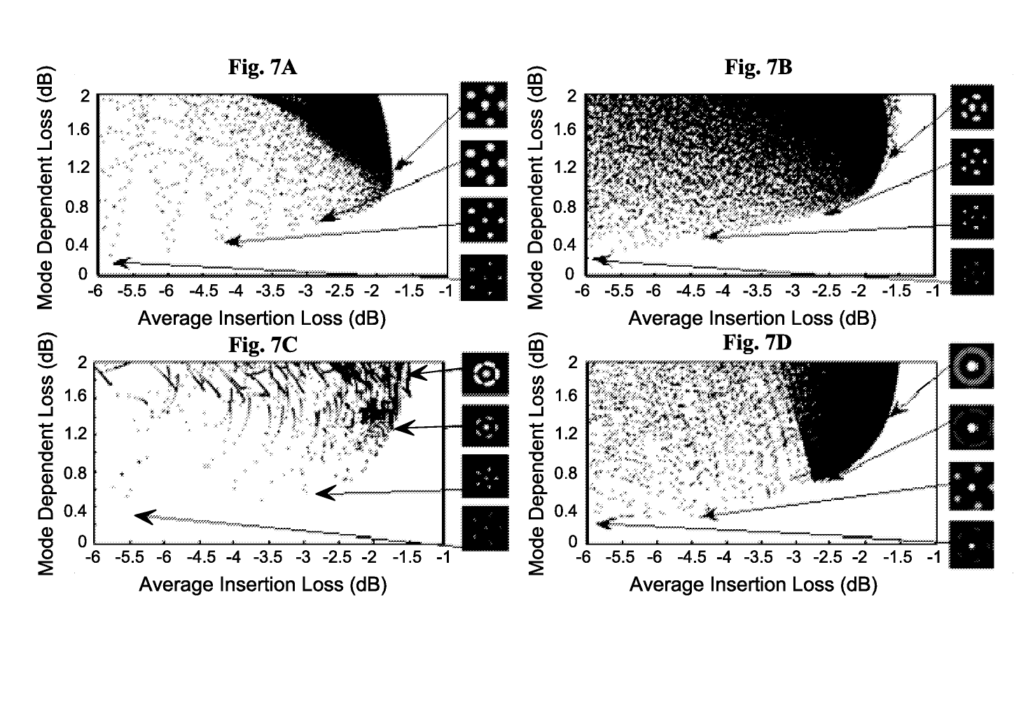

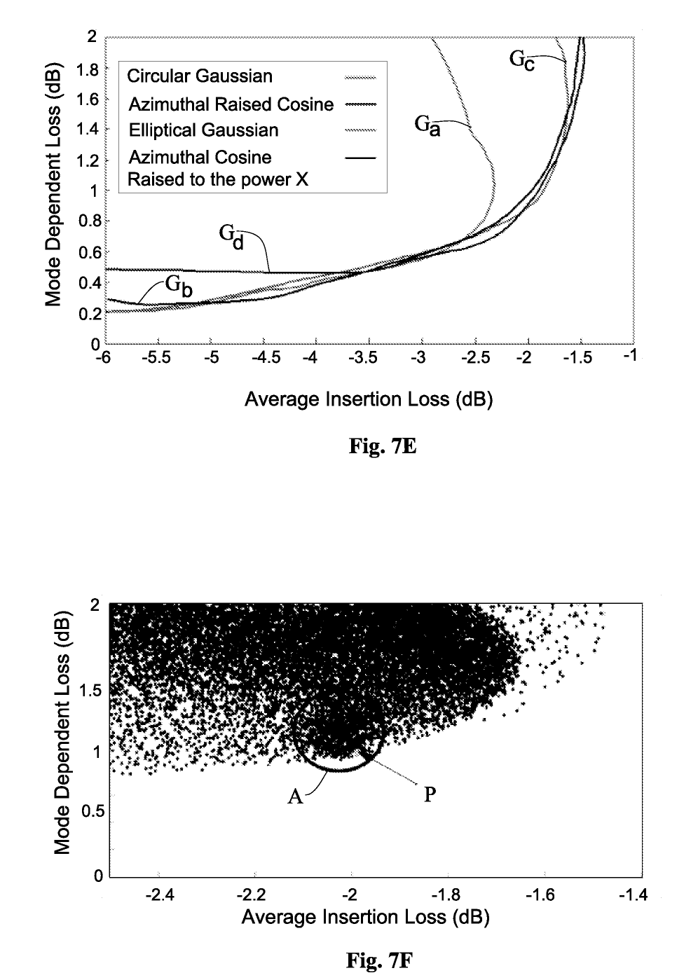

In operation 330, one or more degrees of freedom (optimization parameters) of the intensity distributions associated with the aperture types are varied and the IL and MDL losses are determined for each variation (i.e. while considering the respective arrangements of the apertures on the MMF facet). Some examples of the results of operation 330 are presented in the scattering plots and graphs of FIGS. 7A to 9E. Specifically in 330, after the aperture types (intensity distribution functional forms of the apertures) and the arrangement of apertures is selected in 310 and 320, the intensity distributions are further optimized by varying one or more degrees of freedom (optimization parameters) associated with each of the aperture/intensity-distribution forms φₖ(x,y). The coefficients of the coupling matrix are calculated for various values of the varied optimization parameters (and possibly also for different shapes/intensity distribution functions and scaling). The coupling matrix is used to determine the coupling losses (e.g. IL and MDL) associated with each such variation of optimization parameters and distribution functions. In this connection, the different intensity distributions of the apertures may be associated with different numbers of degrees-of freedom (optimization parameters). The optimization of operation 330 may be further clarified considering the various degrees of freedom illustrated in FIG. 1D.

Referring to FIG. 1D, the functional forms of the intensity distribution of several examples of different aperture types are exemplified. Specifically, different radial and azimuthal aperture intensity distribution functions are illustrated with varying optimization parameters of these functions. Particularly, in (a), a Gaussian function is illustrated with various widths (e.g. exemplifying a cross-section of the circular Gaussian and/or elliptical Gaussian aperture types indicated below). In (b), radial Bessel function is presented with various values of the scaling and shifting parameters thereof. This radial Bessel function may serve as the radial part of an intensity distribution function separable for radial and azimuthal function-parts. In (c) an azimuthal distribution function in the form of cosine raised to the power is shown. In (d) azimuthal distribution function in the form of adjustable raised cosine function. The azimuthal distribution functions illustrated in (c) and (d) may each serve as the azimuthal part of an intensity distribution function separable for radial and azimuthal function-parts.

With regard to FIG. 1D(a), the optimization parameters of a one-dimensional Gaussian are its width (scaling) and its position. The different graphs in FIG. 1D(a) relate to various values of the width parameter. The elliptical Gaussian case adds a degree of freedom related to an eccentricity of the intensity distribution, thus allowing for better coverage of a desired region in the MMF's optical pupil, and in turn provides for lowering the IL. To this end, the two Gaussian cases have different number of degrees of freedom, and when applying an elliptical Gaussian aperture, the width is not necessarily equal for the radial and azimuthal directions and more degrees of freedom are generated.

As noted above, on some cases separable intensity distribution functions are used for the radial and azimuthal directions. Specifically radial distribution function, R(r), that closely mimics the Bessel distribution may be selected for the radial direction, while utilizing azimuthal distribution function Θ(θ) being the azimuthal raised cosine or the azimuthal cosine raised to power x. For example a radial distribution function R(r) with the following functional form may be used:

$$R ( r ) = \{ \begin{matrix}{J}_{n} ( α ( r + ρ ) ) & {r}_{0} < r \leq {r}_{1} \\ A \cdot {K}_{n} ( β ( r + ρ ) ) & r > {r}_{1}\end{matrix} \qquad ( 2 )$$

This function is illustrated in the graphs of FIG. 1D(b) with several values of its optimization parameters. Specifically, for the radial Bessel intensity distribution the degrees of freedom (optimization parameters) are the radial position parameter ρ, the scaling parameter of the function α, the index of the Bessel function n, and the radii starting position value r₀ and transition value r₁. It should be noted that the normalization constants A and β are dependent variables, and cannot be used as additional degrees of freedom (they serve to ensure the function is continuous). The different graphs in FIG. 1D(b) relate to various exemplary values of the scaling parameters.

An azimuthal intensity distribution in the form of the cosine raised to power x is illustrated for example in FIG. 1D(c). This function has the following functional form, where x it the optimization parameter (the different graphs in FIG. 1D(c) relate to various values of this parameter):

$$Θ ( θ ) {cos}^{x} ( \frac{( 2 n + 1 ) θ}{2} ) \vert θ \vert < \frac{π}{2 n + 1} \qquad ( 4 )$$

where n is the maximal azimuthal order supported by the MMF (this order is 1, 2 and 3 for the three, six and ten modes, respectively). The aperture spans an angular range of ±m/(2n+1), and raised to a variable power x which is the only optimization parameter provided by this function.

Alternatively or additionally for the azimuthal intensity distribution the form of raised cosine which is illustrated in FIG. 1D(d) may also be used for forming 2n+1 separate spots. This azimuthal intensity distribution has the following functional form:

$$Θ ( θ ) = \{ \begin{matrix}1 & \vert θ \vert \leq β \\ 0.5 [ 1 + cos ( \frac{( 2 n + 1 )}{π - ( 2 n + 1 ) β} ( \vert θ \vert - β ) ) ] & β < \vert θ \vert \leq m \leq \frac{π}{2 n + 1}\end{matrix} \qquad ( 5 )$$

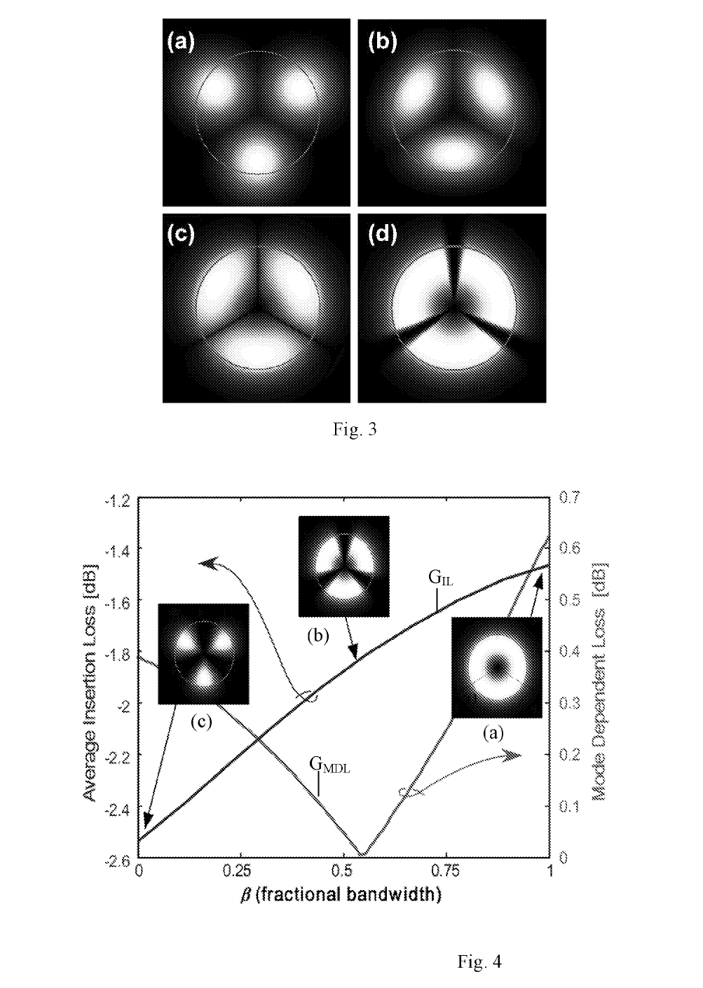

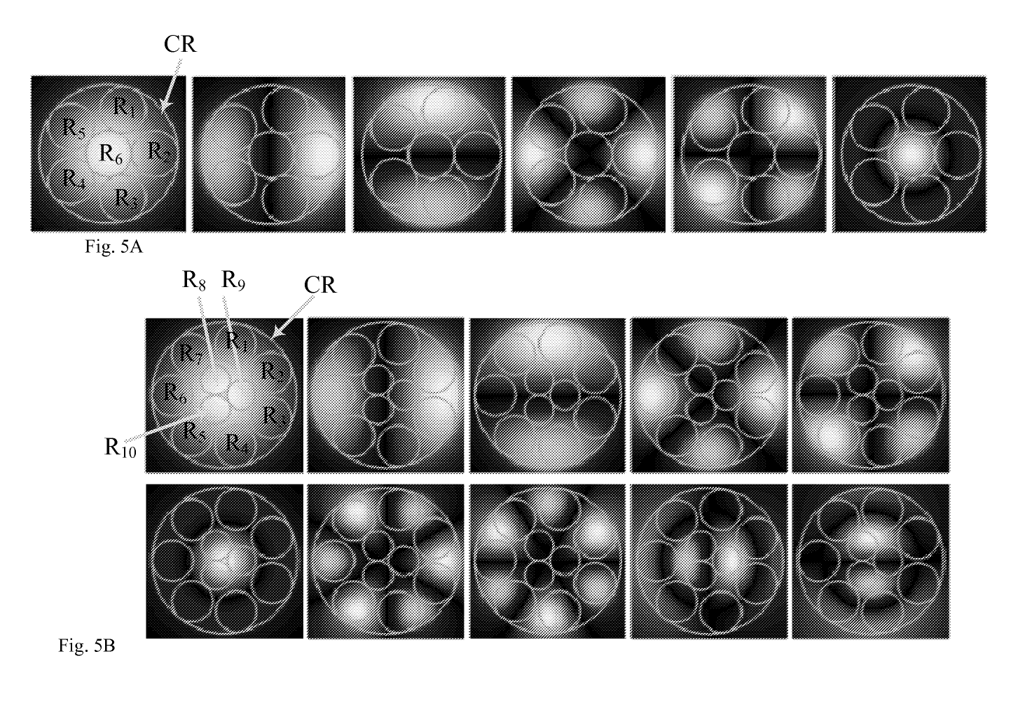

This adjustable raised cosine function is described by two parameters: m and β, wherein m determines the point where the sinusoidal part of the function begins, and as a result the width of the non-zero angular section. The parameter β sets the transition width from zero to one (e.g. sets to transition from zero to the flat top part of the function (see for example FIG. 4). The different graphs in FIG. 1D(d) relate to various values of the β parameter. It should be noted that symbol β used in the description with regard to the adjustable raised cosine function is not related to the Bessel function parameter identified above by the same symbol.

Turning back to method 300 of FIG. 1C, in order to provide sufficient orthogonality of the coupling matrix, the MDL should be below a certain acceptable threshold (herein after MDL threshold). To this end, in 330, the MDL and IL losses of each aperture variation (or of some of them) may be estimated.

In operation 340, aperture variations (being related to specific selection of aperture types, arrangements and optimization parameters), which are higher than predetermined/acceptable IL and MDL thresholds are screened out. Specifically, according to some embodiments of the present invention this threshold is selected in the order of about 0.3 dB. Also, the IL losses should preferably be as low as possible to improve the coupling efficiency. In some cases, a certain maximal IL threshold is selected (for example in the order of −5 dB). Thus, only aperture variations, whose MDL and IL are below these thresholds, remain. This leave only those aperture variations that support sufficient data fidelity and transmission efficiency.

Finally, in 350, the variation in which the arrangement and intensity distributions of the apertures provide the best/optimal coupling may be selected from the remaining variations, for practical use (providing that this variation can be realized by proper configuration of the optical system 100). In this regards, it should be noted that some variations may be associated with low tolerance to misalignments of the fibers with the optical imaging and/or beam shaping modules 110 and 120 (e.g. intolerant to SMF fibers and/or MMF fiber misalignments), and alternatively or additionally some variations of the apertures' types, arrangements, and intensity distribution parameters may require highly accurate optical elements and provide low tolerance to variations in the optical elements of system 100 which might occur in production of such elements. Accordingly, in some embodiments, in 350, predetermined tolerance thresholds (i.e. tolerance data relating to optical elements production tolerances and/or to fiber misalignment tolerances) may be provided, and variation of acceptable ILs and MDLs losses may be further analyzed with the tolerance data to screen out variations requiring highly accurate production/alignment tolerances exceeding the predetermined thresholds. Selection of aperture variation with acceptable tolerances is depicted for example in FIG. 7F.

To this end, from the remaining variations (which can be practically implemented), the variation in which the arrangement and intensity distributions of the apertures provides the best/optimal coupling (e.g. with lowest IL/MDL or with optimized selection of IL and MDL) may be selected.

In this connection, as noted above, reducing the IL and MDL losses during the optical coupling between an SMF's optical pupil and a respective aperture/region at the MMF's optical pupil can be achieved by utilizing both imaging and beam shaping which are aimed together at converting (e.g. projecting/imaging in multiplexing) between the desired intensity distributions φₖ(x,y) at the MMF's pupil and the respective intensity distribution of the signal spatial mode propagating at the respective SMF's. Specifically the system 100 includes:

i. Imaging optics 110 for carrying out method operation 221 for imaging of light traversed in between the SMF's optical pupils SMP₁-SMPₙ onto respective apertures/regions on the MMF's pupil MMP (and/or vice versa when de-multiplexing the optical signals). For example, the optical pupils SMP₁-SMPₙ are being imaged on the respective regions of the optical pupil MMP such that during multiplexing optical signals emanating from each one of the SMFs' optical pupils is focused on its respective aperture of the MMF's pupil MMP, and during de-multiplexing optical field of each aperture of the MMF's pupil is focused onto its respective SMF's optical pupil SMP₁-SMPₙ; and
ii. Beam shaping optics 120 for carrying out method operation 222 for beam shaping the optical signal associated with each of the SMFs to convert their lateral intensity distribution in between a first predetermined intensity distribution at the SMF's pupil and a second predetermined intensity distribution at the respective aperture/region of the MMF's pupil.

In this regards, the second intensity distributions associated with the plurality of SMFs are selected to provide spatial domain multiplexing of the SMFs optical signals in the MMF while reducing at least one of an insertion loss (IL) and mode-dependent losses (MDL) thereby improving spatial domain multiplexing efficiency.

It should be understood that in practice the imaging optics 110 and the beam shaping optics may in some cases be integrated together such that some optical elements may optionally be configured for carrying out both imaging related optical operations, such as light collimation and/or focusing, and also configured to carry out beam shaping related operations, such as wave-front shaping and/or differential lateral attenuation of the beams' intensity. It should also be understood that in some cases, one or more of the optical elements/modules are configured to operate on individual light component associated with the specific SMF (e.g. outputted/entered to the specific SMF). Alternatively or additionally, one or more of the optical elements/modules are configured for operating on multiple light components associated with the plurality of SMF's

It should be noted that in order to enable coupling of the optical signals from N single-mode fibers SMF₁-SMFₙ to a multimode fiber MMF, the number of single mode fibers should not exceed the number of modes that are supported and can be efficiently transmitted through the MMF. According to some embodiments of the present invention the number N of SMFs equals the number of spatial/lateral modes in the multi-mode fiber MMF. Also, according to some embodiments of the invention the optical signals from the N single mode fibers SMF₁-SMFₙ are coupled/imaged to N spaced-apart apertures/regions on the multi-mode fiber MMF. These regions are in some cases distinct non-over-lapping regions. Also typically at least some of these regions are associated with multiple modes of the MMF such that each region substantially overlaps with the intensity distributions of at least two spatial modes in the multi-mode fiber MMF.

In the example of FIG. 1A, the imaging optics 110 includes collimation optics 110A which is configured to collimate light components emanating from (associated with) the SMFs during space domain multiplexing operation of the system 100 (configured to focus light components onto their respective SMFs during the de-multiplexing operation of the system 100). Also the imaging optics 110 includes focusing optics 110B which is configured to focus the light components of respective SMFs (e.g. after the intensity distribution and/or wavefront of these light components had being shaped) onto their corresponding apertures/regions during multiplexing operation (e.g. during de-multiplexing operation, the focusing optics 110B operate to collimate light emanating from the respective regions of the MMF's pupil). Accordingly, the functional operations of the two optical modules 110A and 110B are interchanged in de-multiplexing, such that the module 110A performing collimation in multiplexing, performs the focusing in de-multiplexing and vice-versa, the module 110B performing focusing in multiplexing, performs the collimation in de-multiplexing.

Beam shaping optics 120 may be configured based on various known in the art beam shaping techniques, all in accordance with desired efficiency, accuracy and costs. For example, beam shaping may be performed utilizing intensity re-distribution and phase/wavefront correction techniques which are typically based on two or more refractive and/or diffractive optical elements. Alternatively or additionally, beam shaping may be based on intensity attenuation elements (e.g. filters) having differential lateral attenuation configured to convert from one lateral intensity distribution of the beam passing therethrough to form another intensity distribution of the beam. It should be understood that the beam shaping is aimed at converting in between a first predetermined intensity distribution of light propagation in the single-mode fibers, which is typically a substantially circular Gaussian intensity distribution, and another/second predetermined intensity distributions at the respective apertures/regions of the MMF. As will be further described below in more details, the second intensity distributions are specifically selected according the invention based on the type of the multi-mode fiber MMF being used (e.g. according to the number of spatial modes supported thereby) and according to a desired optimization sought (e.g. more prone to reducing insertion losses and/or more prone to reducing MDL losses). The second intensity distributions on the plurality of apertures are generally selected such that a coupling matrix relating the apertures and the multiple spatial modes of the MMF is substantially orthogonal matrix. To this end, specific examples with 3, 6 and 10 mode MMFs are described in more details below.

According to some embodiments of the present invention, efficient beam shaping (i.e. with high accuracy and low losses) may be obtained by known beam refractive and/or diffractive beam shaping techniques. These technique utilize at least a pair of optical modules/elements which are spaced apart along the optical axis of general propagation of the light beam to be shaped, wherein a first optical module is configured to affect the lateral intensity distribution of that light beam, such that a desired intensity distribution is obtained at the optical plane of the second optical module, and the second optical module is configured to adjust the phase/wavefront of the light beam such that the desired intensity distribution is substantially preserved (e.g. to form plane wave). Typically, these techniques may be implemented utilizing a pair of refractive optical elements (e.g. refractive lenses) and/or a pair of diffractive lenses (e.g. Fresnel lenses) such that one is an intensity distribution optical element and the other one is a wavefront correction optical element. Such beam shaping technique implemented utilizing the refractive lenses is described for example in U.S. Pat. No. 3,476,463. It is also known to implement the same principles of beam shaping utilizing intensity redistribution and wavefront correction by utilizing diffractive optics/elements and possibly also by utilizing two or more optical elements. Such beam shaping techniques are generally associated with high efficiency and low losses. In this connection it should be understood that the functional operations of the two elements are interchanged in de-multiplexing such that the element performing intensity redistribution in multiplexing, performs the phase/wavefront correction in de-multiplexing and vice-versa. Also it should be noted that in some embodiments the intensity distribution and phase correction modules of the beam shaping module 120 may be integrated with the optical elements of the imaging optics for example by integrating the functional operations of the collimation optics 110A and the intensity distribution module in the same optical element/module, and/or by integrating the functional operation of the focusing optics 110B and the phase correction module in the same optical element/module.

Alternatively or additionally, beam shaping may also be obtained utilizing anamorphic imaging elements for example to stretch/shrink the intensity distribution of the light beam with respect to a certain lateral axis/direction. Also, as noted above, another beam shaping technique which may be used by the present invention is referred to herein as attenuating beam shaping techniques which utilizes an optical filter to differently attenuate light rays of the light beam to be shaped and thereby accomplish the beam shaping. Typically, in such beam shaping techniques, specifically designed spatially inhomogeneous natural-density (ND) optical filter(s) is used to attenuate and shape the intensity distribution of light beams (i.e. the one or two dimensional lateral intensity profile of light). The spatial distribution of the filtration properties in the filter are designed in accordance with the lateral intensity distribution of the incoming light beam and the desired lateral intensity distribution to be obtained in the output. Indeed such filters are typically associated with reduced efficiency as compared with beam shaping techniques which rely on intensity re-distribution and wavefront correction, however, in some embodiments of the present invention such techniques may also be used. In this regards, such a beam shaping filter may also be integrated with one or more of the optical elements of the imaging optics 110.

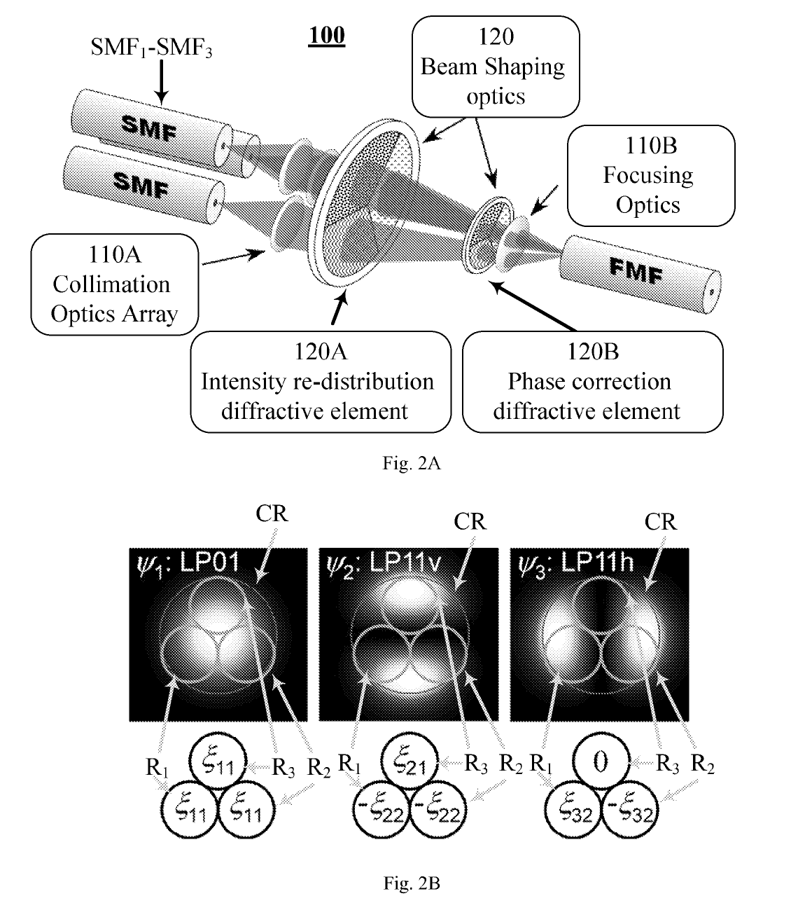

Reference is made to FIG. 2A showing an example of the spatial aperture sampling mode multiplexer system 100 according to an embodiment of the present invention. System 100 is configured for space domain multiplexing/de-multiplexing (spatial mode multiplexing) of light signals of three single mode fibers, SMF₁-SMF₃ from/to a single few-mode fiber (i.e. multimode fiber) FMF which supports three spatial lateral modes. It should be understood that the principles of the invention are not limited to any specific number of modes/fibers. In this example, aperture shaping for a spatial aperture-sampling mode multiplexer/demultiplexer is obtained utilizing three collimation lenses 110A respectively configured and operable to collimate the separate three SMFs beams. The collimated beams are shaped utilizing diffractive optical elements 120A and 120B configured to apply desired intensity-redistribution and phase/wavefront-correction to the SMFs' beams of the correction, and a focusing lens 110B configured for focusing the shaped SMFs' beams onto desired regions/apertures at the optical pupil of the FMF. The beam shaping elements are implemented here by two space-variant, phase-only diffractive optical elements (DOEs) which are each segmented to three regions that are respectively configured for operating on the corresponding SMFs' beams (e.g. to affect its lateral intensity and/or wavefront). The single focusing lens 110B is used herein to focus all the SMFs' beams being shaped onto the predetermined regions at the pupil of the FMF. As noted above, the functional operation of the modules/elements 110A and 110B, as well as elements/modules 120A and 120B is interchanged in multiplexing and de-multiplexing operations of system 100, during which the optical signals propagate in opposite directions (form the SMFs to the MMF in multiplexing and vice versa in de-multiplexing). To this end the optical modules 110A, 110B, 120A and 120B are termed here in accordance with their principal function during multiplexing which is typically inverted during de-multiplexing.

It should be noted that typically the intensity redistribution and the phase correction optical elements are arranged spaced apart from one another (e.g. since typically the intensity redistribution optics 120A is configured such that a desired intensity distribution of the SMFs' beams is obtained at a certain distance downstream therefrom at which the optical plane of the phase correction optics 120B resides). Nevertheless, in some cases the collimation optics 110A may be integrated with the intensity redistribution optics 120A and/or the focusing optics 110B may be integrated with the wavefront correction optics 120B.

System 100 of FIG. 2A is specifically configured to optimize the coupling criterion (reduce IL and MDL losses) by modifying the shape/geometry and intensity distributions at the respective apertures/regions of the FMF's pupil (facet) at which the respective SMF's beams are imaged. In these specific embodiments, by placing space variant optical elements/modules between the SMFs and the FMF, the IL may for example be reduced to −1.5 dB while maintaining low level of MDLs below 0.2 dB.

Turning now to FIG. 2B there are illustrated three intensity distributions ψ₁-ψ₃ of respectively three linearly polarized spatial modes LP01, LP11v and LP11h of a three mode fiber such as FMF illustrated in FIG. 2A. The enclosing circles CR present the MMF's core (i.e. present the optical pupil MMP of the MMF) while the regions R1-R3 present regions/apertures of the facet/pupil of the MMF, at which the beams of respective SMF₁-SMF₃ are coupled to the MMF (e.g. being imaged thereon). The coupling coefficients ξᵢⱼ between the intensity distributions ψᵢ(x,y) of the three spatial modes and beams/spots associated with the SMFⱼ are also illustrated in the figure (note that here x and y are the spatial lateral coordinates across the facet/pupil of the MMF (i.e. the two Cartesian coordinates perpendicular to the fiber's longitudinal direction being the general direction of light propagation through the fiber).

In this example of FIG. 2B, the respective regions R1-R3 corresponding to the apertures of SMF₁-SMF₃ are arranged with a 120° azimuthal symmetry (this arrangement is achieved by proper configuration of the imaging and beam shaping modules 110 and 120 in FIG. 2A). The 120° azimuthally symmetry provides that coupling coefficients ξᵢⱼ between spatial mode i and SMF j satisfy the following:

ξ₁₁=ξ₁₂=ξ₁₃→(all are thus depicted in the figure as ξ₁₁).

ξ₂₂=ξ₂₃→(accordingly both are depicted in the figure as ξ₂₂).

ξ₃₁=0→(as depicted in the figure).

ξ₃₂=−ξ₃₃→(accordingly both are depicted as ξ₃₂ in the figure).

Due to those symmetry considerations the matrix ξ satisfies the orthogonality criterion.

Turning now to FIGS. 3A to 3D simulations of four intensity distribution (apertures) are illustrated subtending the three modes of the three-mode MMF's fiber core. The simulations/intensity distributions illustrated here and in FIG. 4 below were performed with LP modes obtained from analytic solutions to the step-index dielectric fiber wherein an SMF radius of 4.4 microns, Δn=0.1 (V=1.997) and FMF radius of 6.5 microns, Δn=0.13 (V=3.613), were considered (V being the normalized frequency). It should however be noted that the technique of the present invention can also be adapted to and used with other types of fibers which may have other refractive index distributions.

FIG. 3A depicts the conventional Circular Gaussian aperture type which coupling can be achieved by the conventional Spatial Aperture-Sampled Mode Multiplexer without using beam shaping and by imaging of the Circular Gaussian intensity distribution of the SMFs modes onto properly arranged regions (R1-R3) in the MMF's pupil. To this end, the arrangement of apertures FIG. 3A is provided for comparison purposes with the optimized Spatial Aperture-Sampled Mode Multiplexing technique of the invention which is optimized by specifically designed beam shaping. FIG. 3B shows the intensity distribution of the aperture type being beam shaped to elliptical Gaussian intensity distribution with 0.79 eccentricity. FIG. 3C illustrates an aperture type having the intensity distribution with radial Bessel distribution and azimuthal distribution being cosine raised to 0.3 power. FIG. 3D illustrates an aperture type intensity distribution with radial Bessel distribution and with azimuthal distribution in the form of adjustable Raised cosine function with β=0.785.

Thus the simplest apertures to consider are circular Gaussian beams of FIG. 3A, which can be implemented by imaging the three SMF modes onto the three-mode FMF. The beam diameter and radial distance are the only parameters to vary. Optimization yields the following coupling coefficient matrix:

$$ξ = [ \begin{matrix}0.466 & 0.653 & 0 \\ 0.466 & - 0.328 & 0.567 \\ 0.466 & - 0.328 & - 0.567\end{matrix} ] ⇒ \begin{matrix}\overline{IL} = - 1.90 dB \\ MDL = 0.07 dB\end{matrix}$$

The LP01 mode equally excites all three apertures, the LP11h results in one null aperture due to symmetry and an equal division of the energy between the two other apertures. In the LP11v case it is clear that a sufficient condition to ensure orthogonality according to Eq. (2) is |ξ₂₁|=2|ξ₂₂|. The calculated coefficient values are consistent with the relationships anticipated from symmetry considerations, as shown FIG. 2B.

FIG. 3B illustrates more generalized intensity distribution form of elliptical Gaussian beams. Obtaining the intensity distribution of these apertures is achieved by utilizing specifically configured beam shaping modules which introduce an ellipse eccentricity. Here, the ellipse eccentricity parameter (which is a fixed/configurable parameter of the beam shaping) is utilized as an optimization parameter for the coupling coefficient matrix. Having determined the optimized eccentricity value of 0.79 the following coupling matrix is obtained:

$$ξ = [ \begin{matrix}0.475 & 0.667 & 0 \\ 0.475 & - 0.335 & 0.582 \\ 0.475 & - 0.335 & - 0.582\end{matrix} ] ⇒ \begin{matrix}\overline{IL} = - 1.7 dB \\ MDL = 0.05 dB\end{matrix}$$

While the aperture coupling coefficients are quite similar, the coupling efficiency of elliptical Gaussian peaks at an eccentricity value of 0.79 (namely, the minimal insertion losses for the elliptic Gaussian distribution are obtained with this eccentricity value). Beam shaping modules for converting between the circular Gaussian intensity distributions in the SMFs' cores and the elliptical Gaussian intensity distribution at the respective apertures may be achieved by utilizing anamorphic optical elements/lenses which may also be part-of or integrated with the imaging optics.

More complex apertures/intensity distribution can be obtained by creating beams that are defined by separable functions (i.e. separate functions in the in radial, R(r), and azimuthal, Θ(θ), directions). For example, several radial dependencies/functions may be used, such as Gaussian and super-Gaussian of variable width and radial distance.

FIGS. 3C and 3D illustrate two examples of complex apertures/intensity distributions that are defined by separable functions in the radial, R(r), and azimuthal, ι(θ), directions, e.g. by multiplication of those functions. Specifically, in these FIGS. the Bessel dependence was found by the inventors to be a radial functional form providing good results. This function is similar to the radial form of the LP11 modes, namely

$$R ( r ) = \{ \begin{matrix}{J}_{1} ( \frac{κ a}{r} ) & r \leq a \\ \frac{{J}_{1} ( κ )}{{K}_{1} ( γ )} \cdot {K}_{1} ( \frac{γ a}{r} ) & r > a\end{matrix} \qquad ( 6 )$$

where κ and γ are defined by the same way as in the LP11 mode (see reference 11), and a being the core radius parameter (note that this parameter is not related to the physical core radius of the fibers) is an optimization variable of the functional form that was screened/selected for optimizing performance.

In the azimuthal direction, two functional forms are considered and illustrated in FIGS. 3C and 3D respectively. The azimuthal Θ(θ) intensity distribution of FIG. 3D is a cosine scaled to span over ±π/3 and raised to a variable power x, namely serving as an optimization variable for optimizing the coupling matrix, such that

$$Θ ( θ ) = {cos}^{x} ( \frac{3 ϕ}{2} ) \qquad ( 7 )$$

The variable power x serves as an optimization parameter for optimizing the coupling matrix. Good performance was obtained in this case for x≅0.3, which resulted with the following coupling coefficient matrix:

$$ξ = [ \begin{matrix}0.494 & 0.685 & 0 \\ 0.494 & - 0.343 & 0.593 \\ 0.494 & - 0.343 & - 0.593\end{matrix} ] ⇒ \begin{matrix}\overline{IL} = - 1.46 dB \\ MDL = 0.17 dB\end{matrix}$$

The apertures obtained when utilizing an azimuthal Θ(θ) intensity distribution dependence of a raised cosine is illustrated in FIG. 3D. Here, the following raised cosine functional was considered with its endpoints fixed at ±π/3 and a transition width parameterized by β∈ [symbol] 0,1 [symbol] , namely:

$$Θ ( θ ) = \{ \begin{matrix}1 & \vert ϕ \vert \leq βπ / 3 \\ 0.5 [ 1 + cos ( \frac{3}{1 - β} ( \vert θ \vert - \frac{βπ}{3} ) ) ] & βπ / 3 < \vert ϕ \vert \leq π / 3\end{matrix} \qquad ( 8 )$$

The following table summarizes the insertion loss values to each fiber mode of a three mode MMF for each of the intensity distribution depicted in FIGS. 3A to 3D:

| | Power Coupling | | |
|---|---|---|---|
| | Loss [dB] | | |
| Aperture type | LP01 | LP11v | LP11h |
| Circular | −1.94 | −1.92 | −1.93 |
| Gaussian | | | |
| Elliptical | −1.4 | −1.75 | −1.76 |
| Gaussian | | | |
| Cosine raised to | −1.36 | −1.51 | −1.52 |
| 0.3 power | | | |
| Raised cosine p = | −1.82 | −1.82 | −1.81 |
| 0.55 | | | |
| Raised cosine p = | −1.4 | −1.69 | −1.68 |
| 0.785 | | | |

FIG. 4 shows graphs of the insertion losses (graph G_{IL}) and the mode dependent losses (graph G_{MDL}) obtained by utilizing configuration similar to that of FIG. 3D with the aperture intensity distributions based on the Bessel function in the radial direction and raised cosine function in the azimuthal direction. The graphs illustrate the average insertion loss and mode dependent loss for different transitional bandwidth β. Also spesifically shown in FIG. 4 are three intensity distributions (a), (b) and (c) corresponding to particular selection of β values described in the following:

The intensity distributions (a) were obtained by optimizing with the raised cosine azimuthal dependence to minimize the IL losses only, and the fractional transition distance converges onto zero (namely β approaches unity β→1 and the angular dependence becomes rectangular) thereby reaching an average IL losses value of −1.46 dB (similar to the cosine raised to a power of 0.3 case) but with elevated MDL value of 0.61 dB. The resulting apertures appear as a ring split to three equal angular segments. However, the apertures have an abrupt transition which might be complicated to implement using conventional beam shaping modules.

Another optimized result is obtained where the value of the β parameter is at 0.55 (shown the intensity distributions (b)). With this value of the β parameter an insertion loss of −1.8 dB and zero MDL loss is obtained. Yet another interesting optimized result with β value of 0.785 (which is the intensity distribution (c) also shown in FIG. 3D)). Here, the MDL criterion/threshold of 0.3 dB is satisfied providing for substantially orthogonal coupling matrix with the following coefficients.

$$ξ = [ \begin{matrix}0.491 & 0.672 & 0 \\ 0.491 & - 0.336 & 0.583 \\ 0.491 & - 0.336 & - 0.583\end{matrix} ] ⇒ \begin{matrix}\overline{IL} = - 1.6 dB \\ MDL = 0.3 dB\end{matrix}$$

It should be noted that generating the aperture shapes/intensity distributions described by the separable functions (as in FIGS. 3C, 3D and 4) can be achieved for example by utilizing the system configuration illustrated in FIG. 2A. Specifically, such beam shaping may be achieved utilizing two phase-only diffractive optical elements (DOE) placed in cascade, where the first DOE controls the amplitude/intensity distribution of the beam at the plane of the second DOE via diffraction, and the latter DOE adjusts the phase distribution/wavefront to achieve efficient coupling into the MMF. By employing phase-only DOE encoding, theoretically efficient diffraction efficiency may be achieved, reducing the additional insertion losses of the multiplexer to a minimum Typically, in order to utilize this technique to apply beam shaping to the desired apertures/intensity distribution, the aperture functions/intensity distribution are required to be smooth and continuous, to allow both DOEs to be encoded with slowly varying and moderate phase depths. Anti-reflection coating can also be used/applied on the elements of the beam shaping module (120 in FIGS. 1A and 2A) to reduce reflections (e.g. Fresnel reflections) and achieve low loss attributes.

Thus, the performance of a spatial aperture-sampling mode multiplexing technique can improved by optimizing the intensity distribution of the SMFs' beams' apertures (intensity distributions) on the MMF pupil. As shown in FIGS. 3A to 4, the technique of the present invention may be used for multiplexing a threemode fiber with insertion loss value not exceeding −1.5 dB and low MDL of 0.2 dB. This is achieved for example by utilizing an azimuthal intensity distribution function in the form of a cosine raised to 0.3 power.

It should be noted that in some embodiments the optimized spatial sampling technique of the present invention is applied to MMF supporting higher mode counts, thus being scalable, as opposed to the conventional technique utilizing mode conversion solutions in which insertion losses increase together with the mode count.

For example, FIGS. 5A and 5B illustrate the field distributions of modes in the MMFs supporting six and ten spatial modes respectively. Specifically, FIG. 5A shows the linearly polarized modes LPₙₘ of a six-mode step index MMF fiber. FIG. 5B shows the linearly polarized modes LPₙₘ of a ten-mode step index fiber. In both these figures, the core (pupil) of the MMF is outlined and referenced by CR. Also, an outline of the arrangement (e.g. location and relative scaling) of the apertures/regions to which the SMFs' light is respectively coupled is illustrated in the figures. These are marked R1-R6 in FIG. 5A illustrating the coupling of six apertures to the six mode fiber. In FIG. 5BA the regions/apertures are marked R1-R10 to illustrate the coupling of ten apertures to the ten mode fiber.

In the embodiments of FIGS. 5A and 5B, the coupling of plurality of SMFs to MMFs with 6 and 10 modes respectively, is obtained by utilizing step index fiber supporting six and ten modes. Specifically, six SMFs are coupled to the six apertures of the six mode fiber illustrated in FIG. 5A and ten SMFs are coupled to the ten apertures of the ten mode fiber illustrated in FIG. 5B.

FIG. 5C shows the dispersion curve of LP modes in step index fibers. To this end, the V-number range (V being the normalized frequency and defined by V=2π/λ₀*a*sqrt[n₁²−n₀²]) of the MMF step index fibers used in the embodiments of FIGS. 5A and 5B is in the range of 3.8 to 6.4.

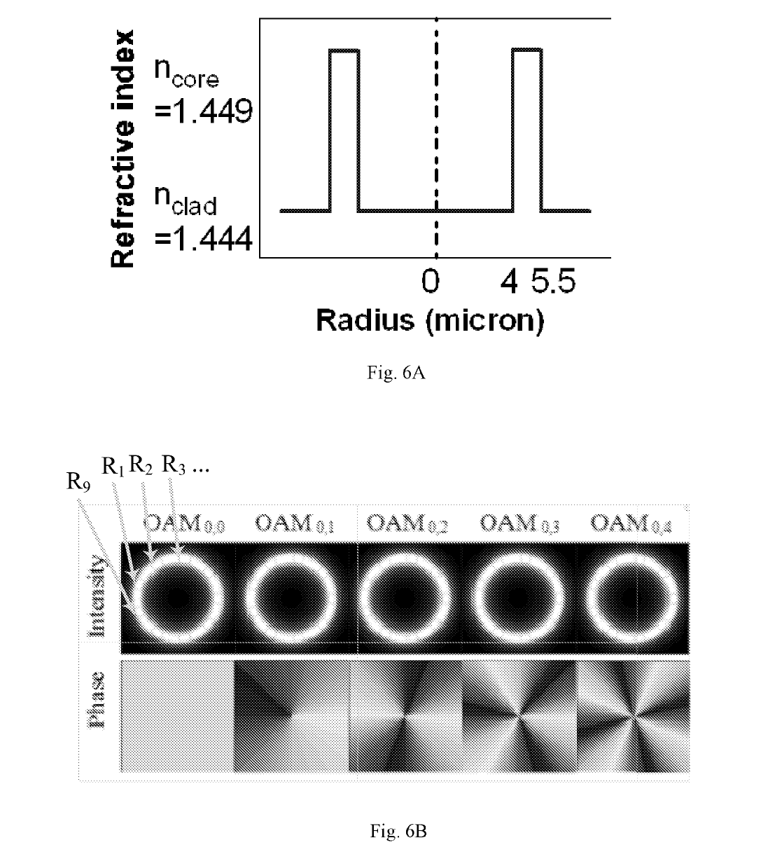

It should be noted that the spatial aperture sampling optimization technique of the present invention can be used/applied with optical fibers of various refractive index profiles (practically with any refractive index profile of the fiber). To this end, FIGS. 6A and 6B, illustrate implementation of the aperture sampling optimization technique according to some embodiments of the present invention preformed with more exotic refractive index profile of a ring fiber of nine modes.

FIG. 6A is a graph illustrating a refractive index profile of the ring fiber, presenting the refractive index as a function of radius. As shown in the figure, in a ring fiber, there are internal and external cladding regions, with the annular core residing in between. Such fibers support orbital angular momentum modes rather than the usual linearly polarized (LP) modes of a step and graded index fibers [16-20].

FIG. 6B is an illustration of the intensity and phase patterns of the propagating OAM modes in the nine mode ring fiber of FIG. 6A. Specifically, FIG. 6B shows five of the negative orbital angular momentum modes (OAMs), OAM_{0,0} through OAM_{0,4}, to the nine modes of the ring fiber, while not specifically depicting the negative momentum modes OAM_{0,-1} through OAM_{0,-4}, which have an opposite phase gradient with respect to modes OAM_{0,1} through OAM_{0,4}. Also, regions R₁, R₂ . . . R₉ corresponding to the arrangement of nine apertures, for coupling nine respective SMF's with the nine modes of the fiber, are outlined in the figure and some of them are specifically referenced by Rᵢ.

As can be seen from FIG. 6B, the orbital angular momentum modes are associated with azimuthal phase dependence of the complex electric field. This dependence can be described by the spatial phase form of exp(ilφ) where i is the imaginary unit and/is the mode index l=0, ±1, ±2 . . . , and φ is the azimuthal angle.

The OAM modes of a ring fiber can be used for transmission through the fiber. The OAM modes maintain modal identity better than LP modes after propagation in the optical fiber, have smaller differential group delay (DGD), and are well supported by a ring refractive index profile fibers such as that of FIG. 6A. These features of the ring fiber may be used to deliver spatial domain multiplexing of data by spatially multiplexing more stable OAM modes in a single optical fiber. Specifically, as the ±l OAM modes are a combination of two matching Eigen-modes of the fiber (i.e. the odd and even EH and HE modes), these modes have the similar propagation constant and thus they do not undergo any intrinsic modal walk-off (this is in contrast to LP modes which emerge under the weakly guiding approximation and are composed of two fiber modes with slightly different propagation constants). As a result, OAM modes maintain mode profile better than LP modes after propagation in optical fiber and have distinct differential group delay (DGD). To this end, the technique of the present invention may be used to optimize mode multiplexing in ring fibers and for providing transmission of data in multiple stable modes in a single optical fiber.

Implementing the optimized spatial aperture sampling multiplexing technique of the present invention with multimode ring fibers is very similar to the implementation of this technique as described above for step index MMFs, with only minor changes related to the special features of the ring fiber. Specifically, according to some embodiments of the present invention the ring fiber is designed/configured to be single moded in the radial direction and to support a number of N azimuthal modes. To this end, the number of azimuthal modes N corresponds to the number of SMFs to be coupled to the ring fiber (i.e. it corresponds to the number of sampling apertures). As indicated above, the OAM modes are degenerate in their phase gradient direction (sign of the l index), except for the basic OAM_{0,0} mode (see FIG. 6B). Therefore the highest azimuthal index propagating in the fiber, l, determines the aperture count according to N=2l+1. Accordingly, when N coherent inputs of the same power and polarization have the phase relationship, namely ΔΦ=Φₙ−Φₙ₋₁2πl/N, a pure OAM_{±l,1} mode will be generated/excited [19].

The optimized mode multiplexing technique of the present invention was simulated for a ring fiber supporting 9 modes (i.e. l=4) such as that illustrated in FIGS. 6A and 6B. Optimizing the multiplexer for the ring fiber utilizing the technique of the invention was simulated for several intensity distribution functions of the apertures.

Specifically, two basic intensity distributions were simulated: circular Gaussian and elliptical Gaussian. In addition, two intensity distribution were simulated which are formed by separable intensity distribution functions in the radial and azimuthal directions. In these cases, for the radial intensity distribution function/form, the exact radial profile of the fiber's fundamental mode was used instead of the Bessel function which was used for the LP modes as indicated above. The exact radial profile of the fiber's fundamental mode was found analytically by solving the propagating mode profiles (accordingly, there was no need for optimization of any degrees of freedom of this radial function). As for the azimuthal intensity distribution functions, in one simulation the raised cosine azimuthal function was used, while in another simulation the azimuthal cosine raised to the power x (Eq. 4 above) was used. To this end, as there were no degrees of freedom to optimize in the exact radial profile there were left only 1 or 2 degrees of freedom for optimization associated with the specific azimuthal function that was used for defining the apertures.

Reference is made together to FIGS. 7A-7D, FIGS. 8A-8D, and FIGS. 9A-9D respectively presenting the optimization results obtained for six, ten mode fibers and for the nine mode ring fiber described above. As described above and also described more specifically below, the optimization of the spatial mode multiplexing was simulated by respectively optimizing the values of the degrees of freedom associated with the arrangement and intensity distribution functions defining the apertures by which the SMFs are coupled to the MMF. As a relatively large number of degrees of freedom are generally optimized, the simulated optimization results are presented in these figures in MDL vs. IL scatter plots, where each point in the plot represents a specific geometry and intensity distribution realization of the apertures (namely each point presents a specific value for each of the optimization parameter as listed above).

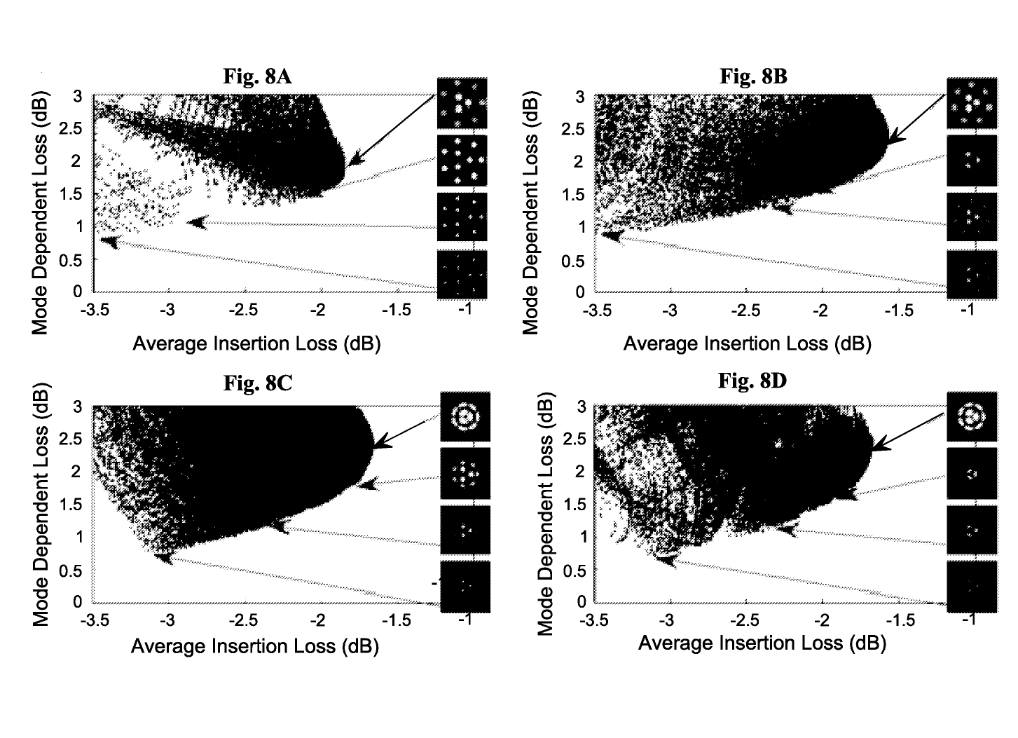

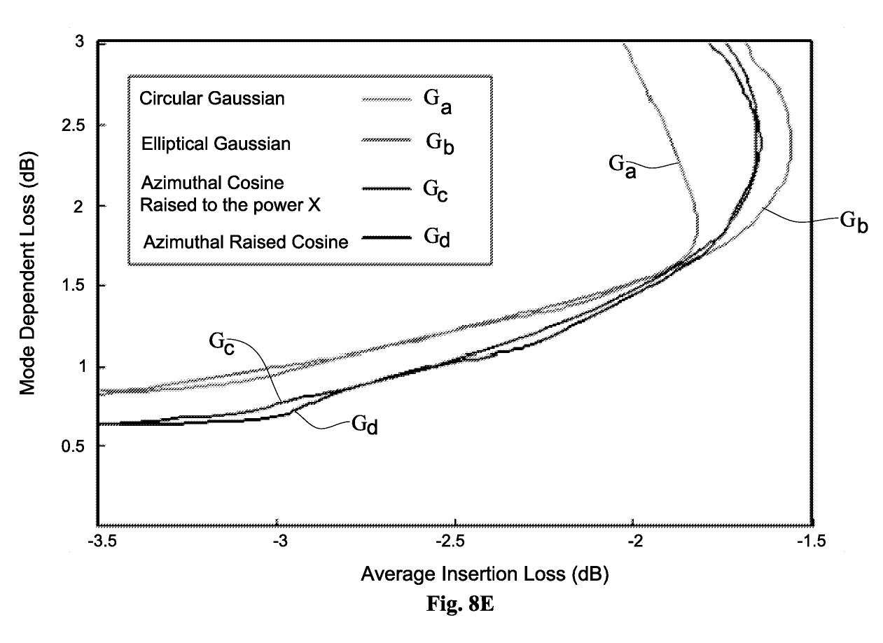

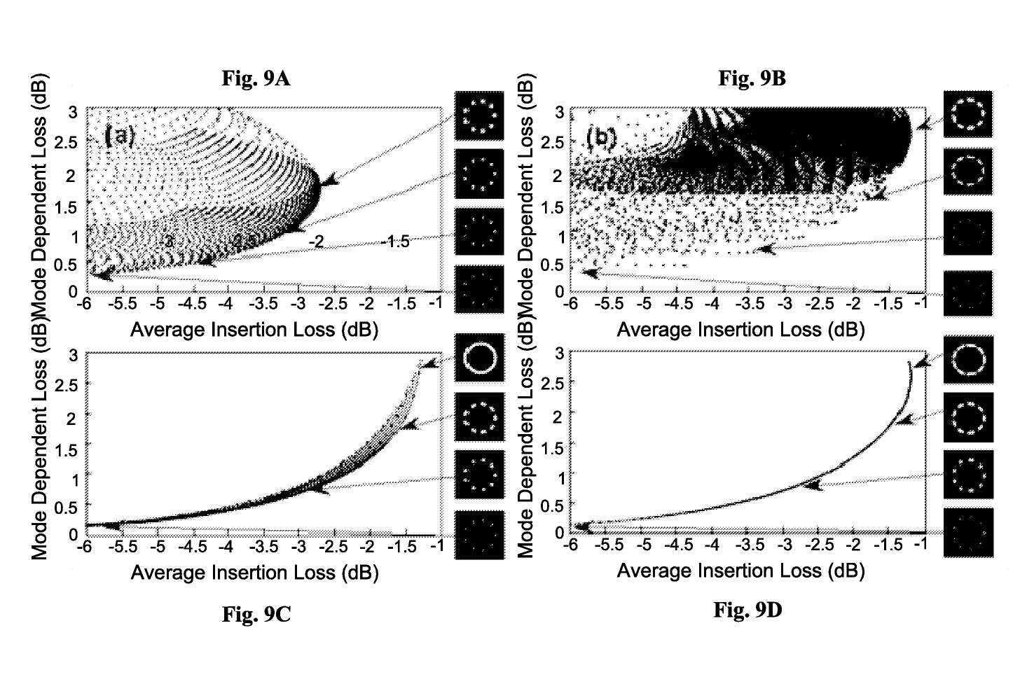

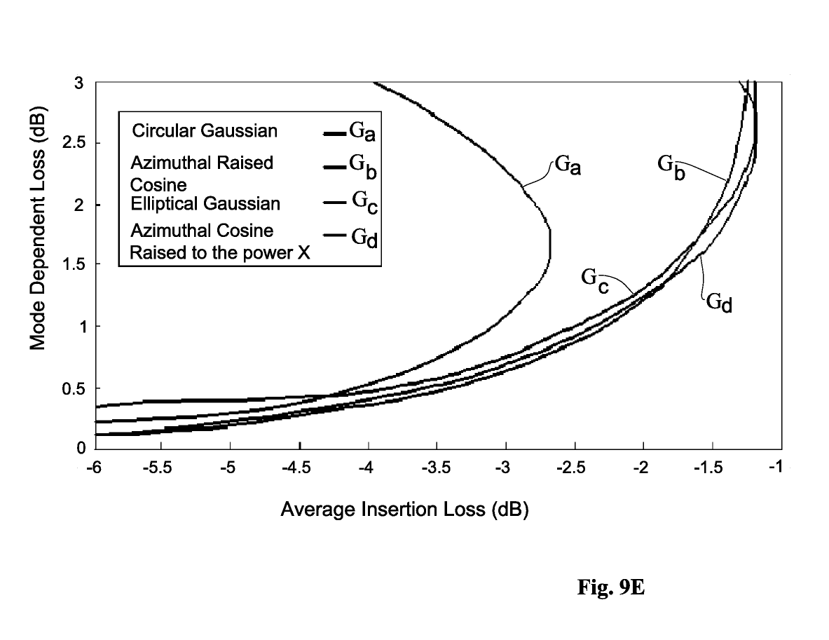

To this end, FIGS. 7A-7D illustrate the aperture optimization results for a six mode fiber as a scatter plot in the MDL vs. IL space. Similarly, FIGS. 8A-8D illustrate the aperture optimization results for the ten mode fiber. Also, FIGS. 9A-9D illustrate the aperture optimization results for the nine mode ring fiber. Each of the plots of FIGS. 7A-9D correspond to optimization of a specific intensity distributions functional form and presents the optimization of the respective degrees of freedom which correspond to the selected distribution. Particularly, FIGS. 7A, 8A and 9A correspond to Circular Gaussian apertures/intensity distribution arranged respectively on the six-mode fiber, ten-mode fiber and nine-mode ring fiber. FIGS. 7B, 8B and 9B correspond to Elliptical Gaussian apertures arranged respectively on the six-mode fiber, ten-mode fiber and nine-mode ring fiber. FIGS. 7C and 8C correspond to the intensity distribution formed by separable Radial Bessel function and azimuthal Raised Cosine function, respectively simulated for the six-mode and ten-mode fibers. FIG. 9C presenting the simulation of the optimization for the nine mode ring fiber with the aperture's intensity distribution formed by separable functions, one corresponds to the exact radial profile of the ring fiber, and the other being the Raised Cosine function presenting the azimuthal intensity distribution. FIGS. 7D and 8D correspond to Radial Bessel function and azimuthal cosine raised to the power x (x<1) dependency apertures, as respectively simulated for the six-mode and ten-mode fibers. Similarly FIG. 9D presents the simulation of the optimization for the nine mode ring fiber with the aperture's intensity distribution formed by separable functions, one corresponding to the exact radial profile of the ring fiber, and the other being the azimuthal cosine raised to the power x.

FIGS. 7A-9D also show, alongside the scattering plots, several apertures arrangements and intensity distributions, with relation (marked by arrow) to the specific point in the plots to which the respective arrangement and distribution of apertures correspond.

As shown in these figures also for the six and ten mode cases, the optimized spatial mode multiplexing technique of the present invention achieves low average IL and MDL losses by selecting properly shaped apertures/intensity distributions and beam shaping and imaging of the SMF's light beams accordingly. As noted above with reference to operation 330 of method 300, each aperture/intensity-distribution is optimized using the various degrees of freedom associated with it.

Specifically, for the simulation of the six mode fiber with the circular Gaussian apertures (which is illustrated in FIG. 7A), determining the optimization parameters consisted of varying three degrees of freedom defining center aperture size, outer aperture size and outer aperture displacement from origin (e.g. displacement form the center of the MMF).

In contrast, six degrees of freedom are optimized in the simulation shown in FIG. 7C, in which coupling to the six mode fiber was performed and simulated utilizing the adjustable raised cosine azimuthal function. Specifically, these optimization parameters include center aperture size, outer apertures displacement, radial function scaling and degree of Bessel function and the two azimuthal degrees of freedom β and m, as described above. As compared to the six mode fiber case, in simulation of the ten mode fiber shown in FIG. 8C (in which also the azimuthal raised cosine function was used and optimized), the center aperture size parameter is replaced by two radial degrees of freedom (function scaling and degree of freedom of the Bessel function) and two azimuthal degrees of freedom (β and m). Also, an additional degree of freedom which is optimized in the ten mode case relates to the arrangement of apertures and specifically to the phase rotation between the internal and external apertures (namely the angular shift between the arrangement of apertures in the outer concentric circle and the arrangement of apertures in the inner concentric circle). To this end, a total of ten degrees of freedom which may be optimized are provided in this case.

For comparison, in the same case of the ten mode fiber, when utilizing the circular Gaussian apertures (simulation presented in FIG. 8A), five degrees of freedom/optimization parameters are introduced. These are specifically internal circle aperture radius and displacement, external circle aperture radius and displacement and the phase rotation between the internal and external circles of apertures.

It should be noted that the general trend obtainable by the aperture optimization technique of the present invention is demonstrated for few specific cases. Particularly, by comparing matching plots of different mode counts (e.g. plot 7A and 8A) it is evident that for fixing the MDL value only a moderate increase in the average IL losses is obtained when increasing the mode count. For a ten mode fiber, MDL<0.5 dB will be obtained with higher average IL than that of MDL<0.5 dB in the six mode fiber case. This is attributed to the more elaborate spatial variations of the intensity within the pupil for higher modes. This property allows utilizing the multiplexing/de-multiplexing technique of the present invention for multiplexing a plurality of tens of SMFs to one MMF having sufficiently high mode count.

Also, the plots in FIGS. 7A-9D reveal that the spatial mode multiplexing involves some tradeoff between the IL and MDL losses. Specifically, by optimizing the various degrees of freedom of each of the simulated aperture geometries/intensity-distribution, to minimize the IL losses results in an elevated MDL losses (top right corner in the scattering plots) and vice versa, optimizing the degrees of freedom of the apertures for minimizing the MDL losses results in elevated IL losses (bottom left corner).

This is specifically because a negligibly small MDL is obtained when the optimization parameters are selected such that apertures are relatively small, since in such a case the coupling into each mode is reduced to the point where they are nearly uniform across all modes. However, when optimizing for the best reduction of IL losses, wide apertures which significantly overlap with most modes are used. The wider apertures have higher IL losses values for modes with fine structures (high m,n values).

It should be noted that the computational complication of an optimization process, such as that described in method 300 above, quickly escalates for high mode counts and aperture degrees of freedom. An exhaustive search of the whole optimization area can be done at coarse of sampling resolution or alternatively endure very long calculation times, so a more directed search is required.

Thus, according some embodiments of the invention, some additional methods are used to improve the search for the optimized aperture variation. First, the aperture arrangement over the fiber's facet has to match the mode pattern. As can be seen, in FIG. 5B, the higher radial order modes form two rings of intensity, and the apertures' arrangement form two circles. The confinement of the guided modes within the core decreases for higher modes, and in order to match this pattern the diameter of the outer circle of apertures should be found around the core's edge, such that some of the cladding area is encapsulated by the outer apertures. The diameter of the inner circle of apertures should be in the area of the inner ring of intensity. For a fiber guiding a higher number of modes, the intensity pattern consists of more intensity rings and additional circles of apertures will be needed. These additional circles will be optimized in the area of the diameter of the matching intensity ring, as described above. When optimizing for minimal IL losses, the apertures should collect as much intensity as possible, resulting in large apertures. When optimizing for minimal MDL losses the trend is opposite, leading to point-like apertures where there is little benefit in customized aperture shapes.

Reference is made to FIGS. 7E, 8E and 9E presenting the leading performance edges of the accessible optimization spaces of the various apertures distribution function simulated. Specifically graphs Gₐ-G_{d} in FIG. 7E present respectively the optimized pairs of IL and MDL losses obtained in the scattering plots of FIGS. 7A-7D (these are the points located at the bottom to right edge of scattering plots). Accordingly graphs Gₐ-G_{d} in FIG. 8E and FIG. 9E respectively present the optimized pairs of IL and MDL losses obtained in the scattering plots of FIGS. 8A-8D and FIGS. 9A-9D. The graphs actually present the best obtainable tradeoff between the IL and MDL losses achievable by these simulated apertures' distribution function. To this end, a comparison between the accessible optimization spaces of the different aperture types is presented in these figures for each of the 6 and 10 mode step-index fibers and the nine mode ring fiber.

As can be seen from FIG. 7E, the optimization accessible area (the range of obtainable IL-MDL values) is much smaller when using the circular Gaussian apertures (graph Gₐ) than as compared to that obtainable with the other apertures types (graphs G_{b}-G_{d}). Indeed, for a low MDL target (e.g. achieved by generating very small apertures), the circular Gaussian apertures perform as well as the other aperture shapes. However, in contrast, low average IL requires the efficient power collection over the FMF facet, and the tightly packed circular Gaussian apertures do not efficiently cover a circular optical pupil of the MMF.

As noted above, techniques for implementing systems for space domain multiplexing and beam shaping as well as technique for fiber alignment might be limited in accuracy. To this end, the aperture variation that is practically selected for space domain multiplexing based on the optimized aperture sampling mode technique of the invention should preferably be relatively insensitive to tolerances related to the implementation/manufacturing and fiber alignment.

Referring to FIG. 7F, there is shows a Monte Carlo simulation of the effect of fiber placement error, by introducing independent errors for each SMF input (normally distributed, with 90% of alignment errors within ±0.5 μm). The design starting point is marked P (IL=−1.98 dB, MDL=0.92 dB) and the 1000 trial simulation generates a cloud at the region A in the vicinity of P, showing the resulting IL and MDL values obtained when each one of the six apertures is slightly misplaced. More than 90% of the displaced apertures have IL losses within ±0.12 dB of the design value and the excess MDL range is 0.3 dB. Misalignment can also impact orthogonality of the projections vectors. Nevertheless, the simulation showed very minor deviation from perfect orthogonality (by measuring the angle between the two vectors).

Thus, the present invention provides a novel spatial aperture sampled mode multiplexer technique scalable for large number of modes and various refractive index fiber profiles, and its performance degradation due to misalignment. Optimizing the apertures shapes beyond circular Gaussian expands the accessible optimization space, and allows achieving low average IL losses as well as negligibly small MDL. Since the losses of the optimized spatial aperture sampling multiplexer/de-multiplexer technique of the invention, increase very moderately with higher mode counts, the optimized multiplexer technique of the invention is suitable for interfacing to fibers guiding tens of spatial modes.

1. A method for coupling a plurality of optical signals between a corresponding plurality of single mode optical fibers (SMFs) and a multi-mode optical fiber (MMF), the method comprising:
optically coupling the optical signals of the SMFs with respective spaced-apart regions at an optical pupil of an MMF, such that at least some of said regions partially overlap with a plurality of different spatial modes supported by the MMF;
wherein said optically coupling for each of the SMF optical signals and the respective region at the MMF's optical pupil comprises:
i. Imaging the SMF optical signal propagating in between the associated SMF and said respective region of the MMF to focus the optical signal emanating from the SMF onto the respective region or vice versa; and
ii. shaping said optical signal being focused to convert a lateral field distribution thereof between a first predetermined field distribution corresponding to the SMF's spatial mode and a second predetermined field distribution of said respective region.

2. The method of claim 1, wherein said second predetermined intensity distribution of the region at the optical pupil of the MMF is associated with the excitation of a plurality of spatial modes in said MMF.

3. The method of claim 1, wherein a number of said spatial modes supported by said MMF equals the number of said SMFs.

4. The method of claim 1, wherein said spaced-apart regions are distinct, non-overlapping regions on the MMF's pupil.

5. The method of claim 1, wherein said second predetermined intensity distribution is selected to provided spatial domain multiplexing of the SMFs optical signals in the MMF while optimizing at least one of an insertion loss (IL) and mode-dependent losses (MDL).

6. The method of claim 5, wherein said second predetermined intensity distribution corresponds to at least one of the following field distribution functions:
i. two dimensional Gaussian field distribution with certain eccentricity;
ii. two dimensional field distribution functions defined by separable Radial and azimuthal functional components;
and wherein said first predetermined field distribution corresponds to at least one of the following: Gaussian field distribution, a circular Gaussian field distribution, and a function corresponding to the field distribution of a fundamental mode of the SMF.

7. (canceled)

8. The method of claim 1, wherein the MMF is configured in one the following configurations:
i. the MMF is a step-index fiber, and wherein the spatial modes of the MMF are linearly polarized modes;
ii. MMF comprises a fiber having annular refractive index profile; and wherein the spatial modes of the MMF are orbital angular momentum (OAM) modes.

9-13. (canceled)

14. The method of claim 1, wherein said imaging comprises coupling between the SMF and the respective region of said MMF by collimating the optical signal associated with said SMF.

15. The method of claim 1 wherein said respective spaced-apart regions are arranged with asymmetric arrangement at said optical pupil of the MMF; said asymmetric arrangement comprises an arrangement of the regions in m concentric circles with 2n+1 regions equally spaced along an outer circle of said concentric circles, where m is the highest radial mode order, and n is the highest azimuthal mode order supported by the MMF.

16. (canceled)

17. The method of claim 1, wherein an arrangement of the plurality of regions and said second predetermined field distribution at each of the respective regions are selected such that a coupling matrix relating to projection of the optical signals between the associated SMFs and said regions and to the multiple spatial modes of said MMF is a substantially orthogonal matrix.

18. An optical signal coupling system for coupling optical signals between a plurality of single mode optical fibers (SMFs) and a multi-mode optical fiber (MMF), the system comprises: beam shaping and imaging optics configured and operable together for optically coupling the optical signals of the SMFs with respective spaced-apart regions at an optical pupil of the MMF, wherein said imaging optics comprises focusing optics for focusing the optical signals associated with the SMFs onto the respective region at the MMF's pupil or vice versa; and said beam shaping optics is configured to convert lateral field distribution of each of the optical signals in between a first predetermined field distribution corresponding to a spatial mode of the associated SMF and a second predetermined field distribution at said respective region.

19. The system of claim 18, wherein said imaging optics and said beam shaping optics are configured such that a location of said respective region associated with each of the SMFs and the second predetermined field distribution are associated with the excitation of a plurality of spatial modes of said MMF.

20. The system of claim 18, wherein said beam shaping optics and said imaging optics are configured for optically coupling the SMFs of a number not less than a number of the spatial modes supported by the MMF.

21. The system of claim 18, wherein said imaging optics is configured for imaging said optical signals onto said spaced-apart regions such that said spaced apart regions are arranged in distinct and non-overlapping regions of the MMF's pupil.

22. The system of claim 18, wherein said beam shaping optics is configured such that said second predetermined field distribution optimizes at least one of an average insertion loss (IL) and mode-dependent losses (MDL) associated with mode division multiplexing of the optical signals coupled in between said SMFs and the MMF.

23. The system of claim 18, wherein said beam shaping optics is configured such that said first predetermined field distribution corresponds to at least one of the following: circular Gaussian field distribution, and a function corresponding to the field distribution of a fundamental mode of the SMF.

24. The system of claim 18,
i. wherein said MMF is a step-index fiber and the system is configured for space domain multiplexing/de-multiplexing optical signals between said plurality of SMFs and a plurality of linearly polarized modes said step-index fiber; and
ii. said MMF is a fiber having annular refractive index profile, and the system is configured for mode division multiplexing/de-multiplexing optical signals between said plurality of SMFs and a plurality of orbital angular momentum (OAM) modes said ring fiber.

25. (canceled)

26. The system of claim 18, wherein said beam shaping optics comprises at least one of the following:
i. field re-distribution and wavefront correction optical elements;
ii. anamorphic optical elements; and
iii. attenuating optical elements.

27. The system of claim 26 (i) wherein the beam shaping optics comprises at least one field re-distribution element configured for modifying the field profile of the optical signal propagating in between the associated SMF and said MMF to affect a certain predetermined field profile, corresponding to at least one of said first and second predetermined field distributions, at a certain optical plane intersecting a propagation path of the optical signal, and at least one phase correction optical element positioned at said optical plane and configured for modifying the phase of said optical signal to obtain a plane wave wavefront of the optical signal.

28-29. (canceled)

30. The system of claim 18, wherein said imaging optics comprises one or more collimating optical elements configured to collimate the optical signals associated with one or more of the SMF.

31. The system of claim 18, wherein said imaging optics is configured to provide an asymmetric arrangement of said respective spaced-apart regions at said optical pupil of the MMF; wherein said asymmetric arrangement comprises the arrangement of the regions in m concentric circles with 2n+1 regions equally spaced along the outer circle of the concentric circles, where m being the is the highest radial mode order, and n the highest azimuthal mode order supported by the MMF.

32. (canceled)

33. The system of claim 18, wherein said imaging optics and said beam shaping optics are configured to provide a substantially orthogonal coupling matrix associating projection of the SMFs on said regions with the multiple spatial modes of the MMF.

34. A method for optimizing spatial mode multiplexing/de-multiplexing of signal between a plurality of N single mode fibers and a common multimode fiber, the method comprising:
providing at least one field distribution function which can be synthesized by spatial beam shaping;
selecting an arrangement of N regions in an optical pupil of said MMF and optimizing scaling of said field distribution functions in each of said regions in accordance with said arrangement;
varying one or more degrees of freedom, being optimization parameters, of said intensity distribution function, while estimating at least one of an insertion loss (IL) and mode-dependent loss (MDL) associated one or more variations of said degrees of freedom and comparing said variations with respective thresholds of at least one of said IL and MDL to screen out variations exceeding said thresholds,
thereby providing one or more variations, each corresponding to a specific arrangement of said regions, and to optimized parameters of specific intensity distribution functions, for which said IL and MDL losses are optimized.

35. The method of claim 34 comprising providing tolerance thresholds associated with at least one of production tolerances and fiber alignment tolerances related to said spatial mode multiplexing, and screening out variations which require accuracy higher than said tolerances.
